(19) United States
(12) Patent Application Publication
(10) Pub. No.: US 2014/0040353 A1
(43) Pub. Date: Feb. 6, 2014

(54) RETURN-LINK OPTIMIZATION FOR FILE-SHARING TRAFFIC

(71) Applicant: ViaSat, Inc., Carlsbad, CA (US)

(72) Inventors: William B. Sebastian, Falmouth, MA (US); Peter Lepeska, Boston, MA (US); Rory J. Murphy, Boston, MA (US)

(73) Assignee: ViaSat, Inc., Carlsbad, CA (US)

(21) Appl. No.: 14/046,781

(22) Filed: Oct. 4, 2013

Related U.S. Application Data
(63) Continuation-in-part of application No. 12/651,928, filed on Jan. 4, 2010.
(60) Provisional application No. 61/170,359, filed on Apr. 17, 2009.
(60) Provisional application No. 61/144,363, filed on Jan. 13, 2009.

(51) Int. Cl. H04L 29/08

(52) U.S. Cl. CPC H04L 67/06
USPC 709/203

(57) ABSTRACT

Methods, apparatuses, and systems for return-link optimization are provided. Embodiments identify upload-after-download content (e.g., file sharing content) upon download, and generate one or more identifiers characterizing the content (e.g., a digest). The identifiers are stored in a client-side server dictionary model reflecting a presumption that the content is stored in a server-side dictionary. When content is later uploaded, the server dictionary model is used to identify when the upload content matches previously downloaded content. When a match is detected, the stored identifiers are used to generate a highly compressed version of the upload content, which is then uploaded to the server instead of uploading the full content data. In some embodiments, similar techniques are used to optimize return link bandwidth usage for upload-after-upload transactions.

### CROSS-REFERENCES

This application claims the benefit of and is a continuation-in-part of non-provisional U.S. application Ser. No. 12/651,928, titled “RETURN-LINK OPTIMIZATION FOR FILE-SHARING TRAFFIC” which claims priority from U.S. Provisional Application Ser. No. 61/144,363, filed on Jan. 13, 2009, titled “SATELLITE MULTICASTING”; and U.S. Provisional Application Ser. No. 61/170,359, filed on Apr. 17, 2009, titled “DISTRIBUTED BASE STATION SATELLITE TOPOLOGY,” all of which are hereby expressly incorporated by reference in their entireties for all purposes.

### BACKGROUND

This disclosure relates in general to communications and, but not by way of limitation, to optimization of return links of a communications system.

In some satellite communications systems, a single user plays a dual role of client and server (e.g., in a peer-to-peer environment). For example, a user may desire to share previously downloaded content with another user. Certain types of local networking and/or shared caching techniques may be used to limit redundancies and/or other inefficiencies associated with these types of transactions. However, the techniques may rely at times on users sharing a subnet, relatively symmetric client-server storage capabilities, relatively symmetric upload-download capabilities of the network links, or other types of network characteristics.

Additionally, specialized peer-to-peer file sharing protocols such as BitTorrent®¹ are a large percentage of overall network traffic worldwide. BitTorrent traffic alone is estimated to take up to 15% of bandwidth worldwide, and up to 50% of all upload traffic in North America, creating a huge usage of network resources. The widespread use of BitTorrent technology takes a large amount of bandwidth in many networks, and many internet service providers (ISPs) impose traffic throttling of BitTorrent traffic along with peer-to-peer caching in an attempt to keep the bandwidth used by BitTorrent from overwhelming available resources.

As such, it may be desirable to further mitigate inefficiencies associated with these types of communications while avoiding limitations of current approaches.

### SUMMARY

Among other things, methods, systems, devices, and software are provided for improving utilization of a communications system (e.g., a satellite communications system) through techniques referred to herein as return-link optimization. Embodiments operate in a client-server context (or a more generalized sender-receiver context). When content is downloaded by a client from a server, a client optimizer intercepts the download and generates one or more identifiers characterizing the content (e.g., a digest). The identifiers are stored in a client-side server dictionary model reflecting a presumption that the content is stored in a server-side dictionary. In some embodiments, the actual data blocks (e.g., byte sequences) making up the content are not stored at the client side; only digests or other identifiers are stored.

Embodiments described herein include systems for intercepting, caching, and retrieving BitTorrent data for use in compression of peer-to-peer communications in order to reduce bandwidth usage for users uploading torrents. In standard systems, traffic will flow from the outside internet, to a server-side proxy device, over the satellite link to the client-side proxy, and then to the user device. Any subsequent uploads from that user device will flow through the client-side proxy, over the satellite link, through the server-side proxy device, and out into the Internet. Various embodiments described herein cache incoming torrents at the server. Then, when a user device attempts to send a piece that is cached at the server-side, the proxy client will squelch the piece and signal to the server-side proxy device which cached piece was being sent. The server can then send the requested piece, and the system thus avoids sending the full piece over a satellite link.

Additionally, due to limited storage capacity, such a server-side proxy may need to replace and update a cache or dictionary periodically. Since certain embodiments only cache object parts that actually flow through the server-side proxy, systems may be implemented to cache the most popular object pieces seen by the system.

In some embodiments, when content is uploaded by the client at some later time, the server dictionary model is used to identify when the upload content matches previously downloaded (e.g., or, in some embodiments, previously uploaded) content. When a match is detected, the identifiers stored in the server dictionary model are used to generate a highly compressed version of the upload content, which is then uploaded to the server instead of the full content data. In this way, return-link bandwidth usage can be reduced for these types of transactions.

In one set of embodiments, a system is provided for managing return-link resource usage in a communications system. The system includes a local dictionary model configured to store identifiers associated with data blocks stored on a remote dictionary, where the remote dictionary is located at a remote node of the communications system. For example, the remote dictionary may be a server dictionary in communication with a server optimizer. The system further includes a download processor module, configured to: receive a first content data block from a remote device associated with the remote dictionary; store the first content data block in a local store (e.g., a buffer); calculate a first identifier (e.g., a digest) from the first content data block; store the first identifier in the local dictionary model; and remove the first content data block from the local store. The system further includes an upload processor module, configured to: receive a second content data block for upload to the remote device; calculate a second identifier from the second content data block; determine whether the second identifier matches the first identifier stored in the local dictionary model; and when the second identifier matches the first identifier, use the first identifier or the second identifier to compress the second content data block into compressed content.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 shows a simplified block diagram of one embodiment of a communications system for use with various embodiments;

FIG. 2A shows a simplified block diagram of one embodiment of a client-server communications system for use with various embodiments;

FIG. 2B shows a simplified block diagram of an embodiment of a communications system having multiple user systems for use with various embodiments;

FIG. 2C shows a simplified block diagram of an embodiment of a communications system having multiple user systems configured for peer-to-peer communications for use with various embodiments;

FIG. 3 shows a block diagram of an embodiment of a satellite communications system having a server system in communication with multiple user systems via a satellite over multiple spot beams, according to various embodiments;

FIG. 4 shows a block diagram of an embodiment of a communications system, illustrating client-server interactivity through a client optimizer and a server optimizer, according to various embodiments;

FIG. 5 shows a block diagram of an embodiment of a client optimizer having additional storage capacity and mode selection, according to various embodiments;

FIG. 6 shows an illustrative method for performing return-link optimization, according to various embodiments;

FIG. 7 shows an illustrative method for performing return-link optimization for an upload-after-upload transaction, according to various embodiments;

FIG. 8 shows an illustrative method for performing return-link optimization for an upload-after-upload transaction, according to various embodiments;

FIG. 9 shows an illustrative method for performing aspects of return-link optimization for an upload-after-upload transaction, in an embodiment of a proxy-side server device;

FIG. 10 shows an illustrative method for performing return-link optimization for an upload-after-upload transaction in an embodiment of a client-side system.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides certain example embodiments which are not intended to limit the scope, applicability, or configuration of the disclosure. Rather, the ensuing description of various embodiments will provide those skilled in the art with an enabling description for implementing any embodiment, including those not specifically described herein. It is understood that various changes may be made in the function and arrangement of elements without departing from the spirit and scope as set forth in the appended claims.

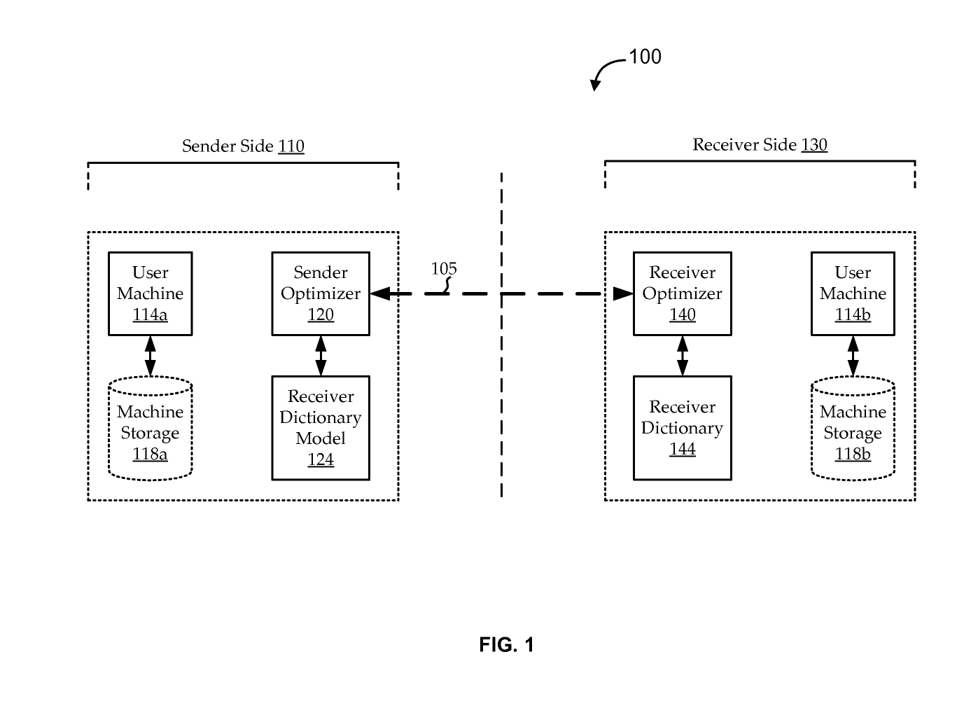

Referring first to FIG. 1, a simplified block diagram is shown of one embodiment of a communications system 100 for use with various embodiments. The communications system 100 facilitates communications between a sender optimizer 120 on a sender side 110 and a receiver optimizer 140 on a receiver side 130. The sender optimizer 120 and the receiver optimizer 140 are configured to effectively provide an optimizer tunnel 105 between the sender side 110 and the receiver side 130 of the communications system 100, including providing certain communications functionality.

Embodiments of the optimizers (e.g., the sender optimizer 120 and/or the receiver optimizer 140) can be implemented in a number of ways without departing from the scope of the invention. In some embodiments, the optimizers are implemented as proxy components (e.g., a two-part proxy client/server topology), such that the optimizer tunnel 105 is a proxy tunnel. For example, a transparent intercept proxy can be used to intercept traffic in a way that is substantially transparent to users at each side of the proxy tunnel. In other embodiments, the optimizers are implemented as in-line optimizers. For example, the optimizers are implemented within respective user or provider terminals. Other configurations are possible in other embodiments. For example, embodiments of the receiver optimizer 140 are implemented in the Internet cloud (e.g., on commercial network leased server space), and embodiments of the sender optimizer 120 are implemented within a user system (e.g., in user's personal computer, within a user's modem, in a physically separate component at the customer premises, etc.).

Various embodiments of optimizers may include and/or have access to different amounts of storage. Some embodiments are configured to cache data, store dictionaries of byte sequences, etc. For example, in the communications system 100, the receiver optimizer 140 has access to enough storage to maintain a receiver dictionary 144. Embodiments of the receiver dictionary 144 include chunks of content data (e.g., implemented as delta dictionaries, wide dictionaries, byte caches, and/or other types of dictionary structures). For example, when content data is stored in the dictionary, some or all of the blocks of data defining the content are stored in the dictionary in an unordered, but indexed way. As such, content may not be directly accessible from the dictionary; rather, the set of indexes may be needed to recreate the content from the set of unordered blocks.

Other embodiments of optimizers have substantially limited storage. For example, in the communications system 100, the sender optimizer 120 has access only to a small amount of storage. The storage capacity may be too limited to store a full dictionary, but sufficient to store a model of the receiver dictionary 144, illustrated as the receiver dictionary model 124. Embodiments of the receiver dictionary model 124 store digests representing data stored at the receiver dictionary 144. For example, as described more fully below, embodiments of the sender optimizer 120 intercept traffic, and use one or more techniques to generate digests of byte sequences of the traffic. The digests are then stored in the receiver dictionary model 124, and can be used to identify matching byte sequences in the receiver dictionary 144.

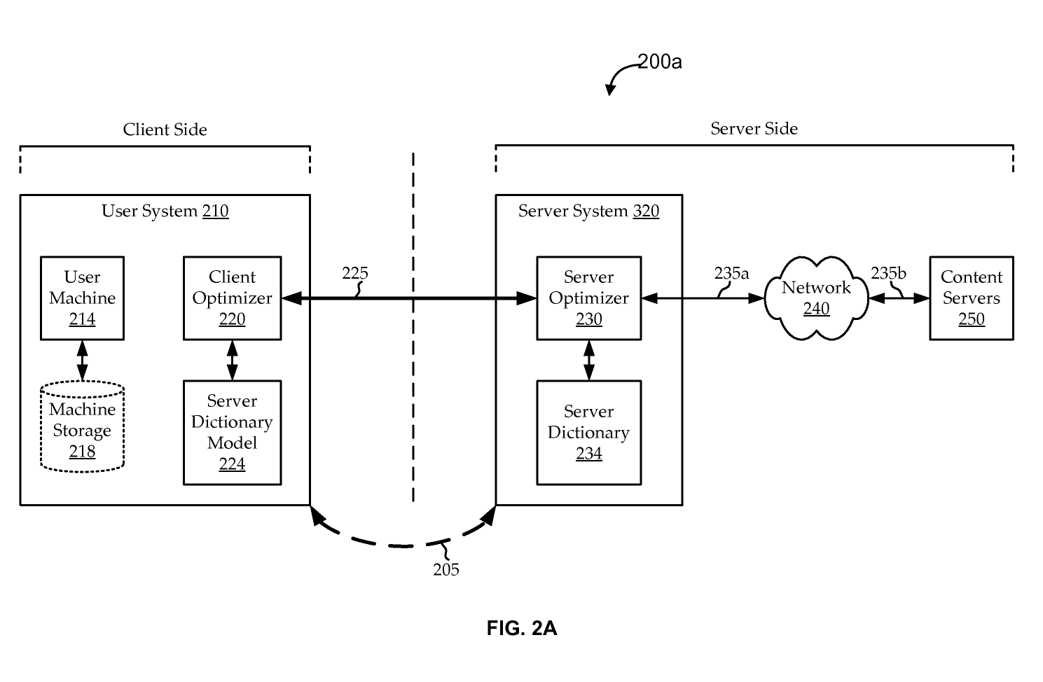

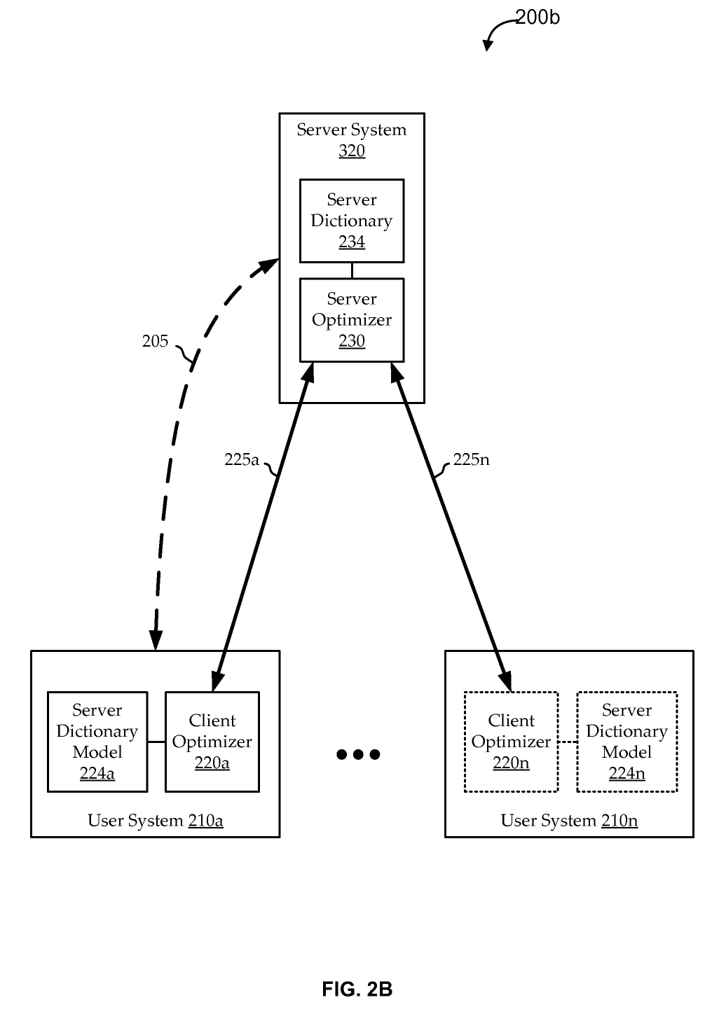

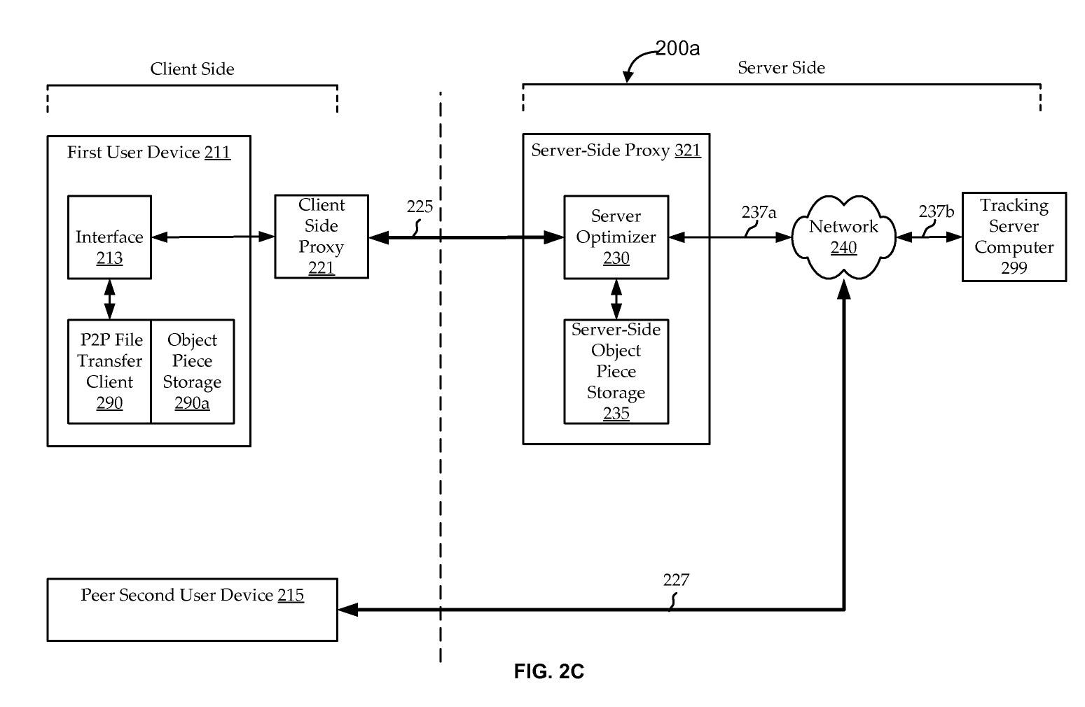

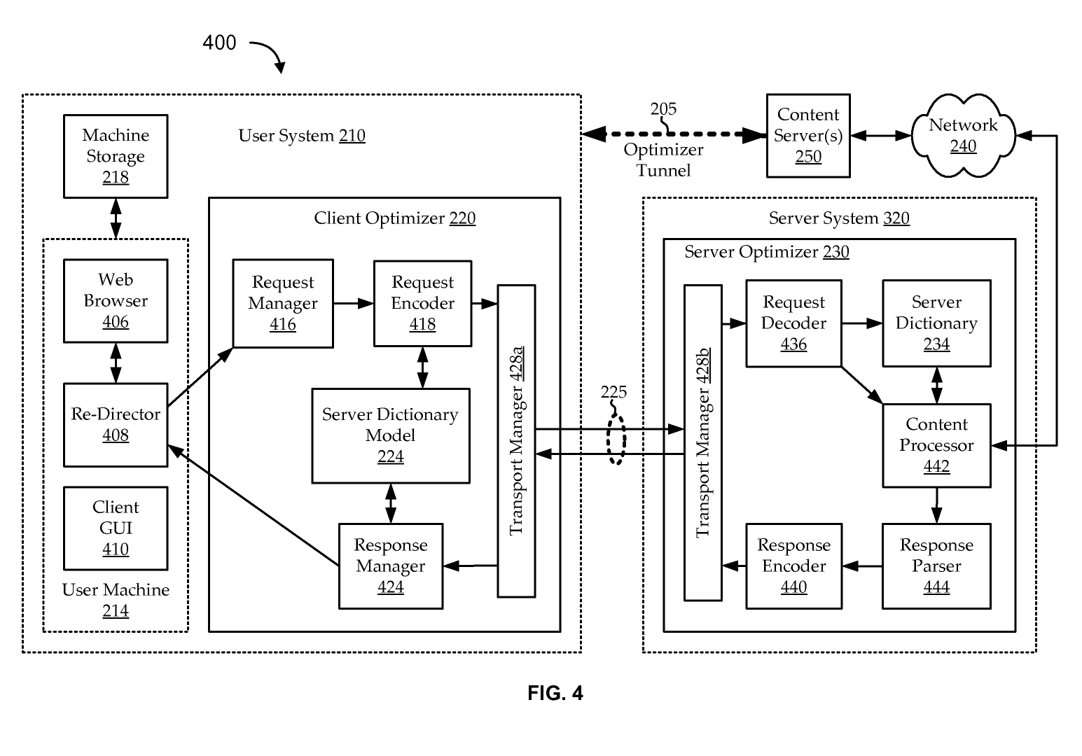

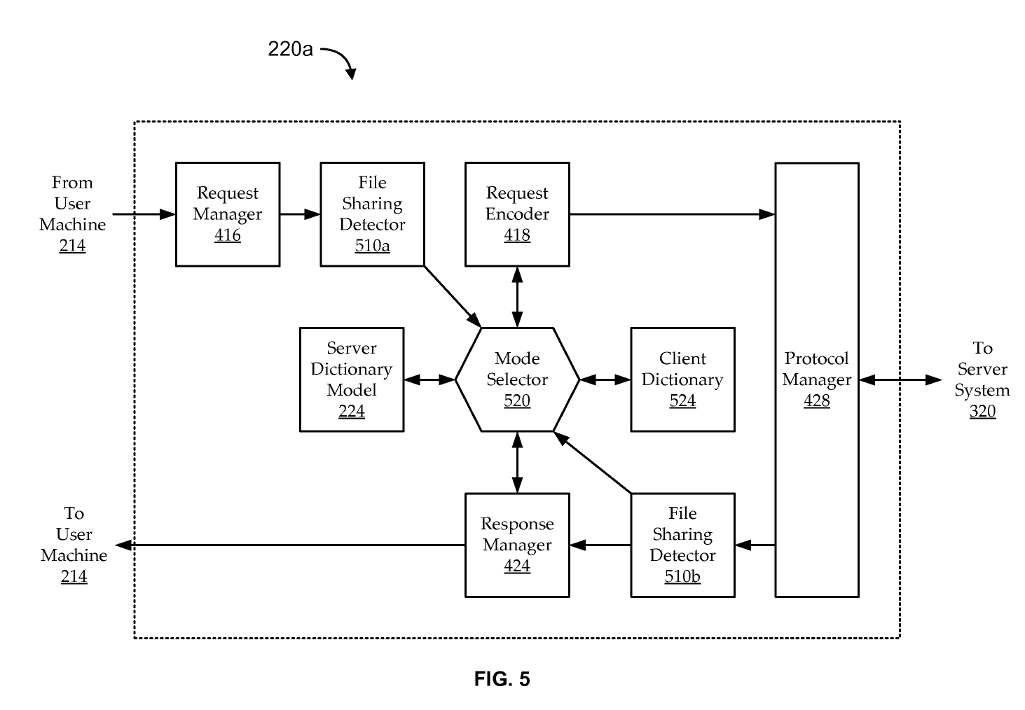

While various embodiments described herein include sender or client-side dictionaries or dictionary models such as receiver dictionary model 124 of FIG. 1, server dictionary model 224 of FIGS. 2A and 4, server dictionary model 224a of FIG. 2B, and client dictionary 524 of FIG. 5, various embodiments may function without dictionaries or dictionary models on a client-side device. While the absence of these dictionaries or models prevents synching with the server-side information, the absence also prevents errors and reduces overhead compared with embodiments that include this client-side information. In certain embodiments, this may introduce too much room for error to keep a client-side dictionary synchronized with the server dictionary. In such embodiments there will only be a dictionary on the server side of the connection. When a request for an upload from a device on the client side is seen on the server side, the server will allow the request to pass through without modification, and then send a server generated identifier for the requested piece to the client optimizer. When the client optimizer receives the actual uploaded piece from the uploading peer, it will generate a digest using the same algorithm used by the server. The client optimizer will then compare the identifier sent by the server optimizer to the identifier generated on the client optimizer, sending the compressed version of the data if the identifiers match and sending the full data otherwise. In such embodiments, this also means that the client optimizer may not determine if a given piece is an optimization candidate, and instead, certain embodiments are structured with optimization decisions made exclusively by a server optimizer. While such embodiments increase processing at the client-optimizer, the absence of a need for synchronization may provide a lower chance for errors in certain embodiments.

As used herein, “digests” may generally include any type of fingerprint, digest, signature, hash function, and/or other functional coding of byte sequences generated so as to provide a strong enough identifier to reliably represent substantially identical matching blocks stored in a dictionary. For example, a user on the sender side 110 of the communications system 100 downloads content from the receiver side 130 of the communications system 100. In one embodiment, the content is intercepted by the sender optimizer 120 and a digest is created and stored in the receiver dictionary model 124. Storage of the digest in the receiver dictionary model 124 indicates that a full copy of the downloaded content is stored in the receiver dictionary 144 on the receiver side 130 of the communications system 100 without storing a copy of the data on the sender side 110 of the communications system 100.

If the user at the sender side 110 later uploads the content to the receiver side 130, embodiments of the sender optimizer 120 intercept the upload to see if the content was previously downloaded from the receiver side 130 (i.e., the content is presumed to be stored in the receiver dictionary 144 according to the receiver dictionary model 124). If the content is determined to be previously downloaded content, a highly compressed version of the content may be uploaded to the receiver side 130. Notably, this technique may allow significant reductions in return-link resource usage for file sharing traffic and/or other upload-after-download traffic, even where there is a very small amount of storage capacity accessible by the sender optimizer 120 (e.g., enough to store only a receiver dictionary model 124).

It will be appreciated that the limited storage capacity at the sender optimizer 120 may be considered differently in different embodiments. In one embodiment, the sender optimizer 120 is implemented within a network device (e.g., a user modem) having minimal storage capacity. In another embodiment, the sender optimizer 120 is configured to operate in different operating modes, where one or more operating modes is configured to use minimal storage capacity. For example, the sender optimizer 120 may operate either in a normal mode that stores dictionary entries for certain types of traffic or in a file sharing mode (when file sharing traffic is detected) that only stores digests without storing the actual file sharing content.

Embodiments of the sender optimizer 120 implement certain functionality described herein when file sharing or similar types of content are detected (e.g., resulting in switching into a file sharing mode, as described above). In some embodiments, the detection involves determining that traffic intercepted during a download is likely to be uploaded at some later time. The determination may account for certain tags or protocols in the metadata, which application is downloading the data, which ports are carrying the traffic, etc. For example, file sharing data may be assumed to have a high probability of upload after download, while Internet-protocol television (IPTV) or voice-over-Internet-protocol (VoIP) content may carry a low probability of upload after download. As used herein, “file sharing” connotes traffic and associated environments in which a downloader of content becomes a provider (e.g., a server) of the content. For example, peer-to-peer and other types of file sharing applications may allow a downloader to become a server in the context of particular traffic.

It is worth noting that many file sharing applications fragment files for communication. For example, some programs allow clients to download a content file in parallel from multiple sources (e.g., other peers on the network) by receiving fragments of the file from each source. As discussed more fully below, embodiments generate identifiers (e.g., digests) at the data block level, rather than at the full-file level. In this way, optimization opportunities may be identified even from file fragments, and even when fragments are received asynchronously, out of order, etc.

It is worth noting that the storage capacity of the sender optimizer 120, as discussed above, may be distinct from other storage capacity at the sender side 110 of the communications system 100. For example, there may be a user machine 114 at one or both sides of the communications system 100. The user machine 114 may broadly include any type of machine through which a user may interact with content over the communications system 100. For example, the user machine 114 may include consumer premises equipment (CPE), such as computers, televisions, etc. Further, as illustrated, the user machines 114 may have access to their own respective machine storage 118. The machine storage 118 may include hard-disk space, application storage, cache capacity, etc.

Notably, the optimizers at each side of the communications system 100 may or may not have access to the respective machine storage 118. For example, embodiments of the sender optimizer 120 may typically have little or no access to the machine storage 118. In some embodiments, the sender optimizer 120 is an independent (e.g., transparent) network component that does not have access to the machine storage 118. In other embodiments, it is inefficient or impractical for the sender optimizer 120 to access machine storage 118 for various optimization processes. For example, access to the machine storage 118 may be too slow to provide desirable optimization benefits. As such, embodiments of the sender optimizer 120 are described as having limited storage capacity (e.g., or operating in a mode with limited storage capacity) even where other storage capacity is available at the sender side 110 of the communications system 100.

While the communications system 100 of FIG. 1 is illustrated generically as a sender side 110 and receiver side 130, some typical embodiments operate in a client-server context. FIG. 2A shows a simplified block diagram of one embodiment of a client-server communications system 200a for use with various embodiments. The communications system 200a facilitates communications between a user system 210 and a server system 320 via a client optimizer 220 and a server optimizer 230. The client optimizer 220 and the server optimizer 230 are configured to effectively provide an optimizer tunnel 205 between the user system 210 and the server system 320, including providing certain communications functionality. Notably, client and server are used herein to clarify particular sides of the communications system, and are not intended to limit the respective roles, functions, direction of communications, etc. For example, in a peer-to-peer context, users may act as both clients and servers in file sharing transactions.

In an illustrative file sharing transaction, the client optimizer 220 and the server optimizer 230 implement functionality of the sender optimizer 120 and the receiver optimizer 140 of FIG. 1, respectively. For example, a user downloads content from a content server 250 over a network 240 through the user system 210. Embodiments of the user system 210 may include any component or components for providing a user with network interactivity. For example, the user system 210 may include any type of computational device, network interface device, communications device, or other device for communicating data to and from the user. Typically, the communications system 200a facilitates communications between multiple user systems 210 and a variety of content servers 250 over one or more networks 240 (only one of each is shown in FIG. 2A for the sake of clarity). The content servers 250 are in communication with the server optimizer 230 via one or more networks 240. The network 240 may be any type of network 240 and can include, for example, the Internet, an Internet protocol (“IP”) network, an intranet, a wide-area network (“WAN”), a local-area network (“LAN”), a virtual private network (“VPN”), the Public Switched Telephone Network (“PSTN”), and/or any other type of network 240 supporting data communication between devices described herein, in different embodiments. The network 240 may also include both wired and wireless connections, including optical links.

As used herein, “content servers” is intended broadly to include any source of content in which the users may be interested. For example, a content server 250 may provide website content, television content, file sharing, multimedia serving, voice-over-Internet-protocol (VoIP) handling, and/or any other useful content. It is worth noting that, in some embodiments, the content servers 250 are in direct communication with the server optimizer 230 (e.g., not through the network 240). For example, the server optimizer 230 may be located in a gateway that includes a content or application server. As such, discussions of embodiments herein with respect to communications with content servers 250 over the network 240 are intended only to be illustrative, and should not be construed as limiting.

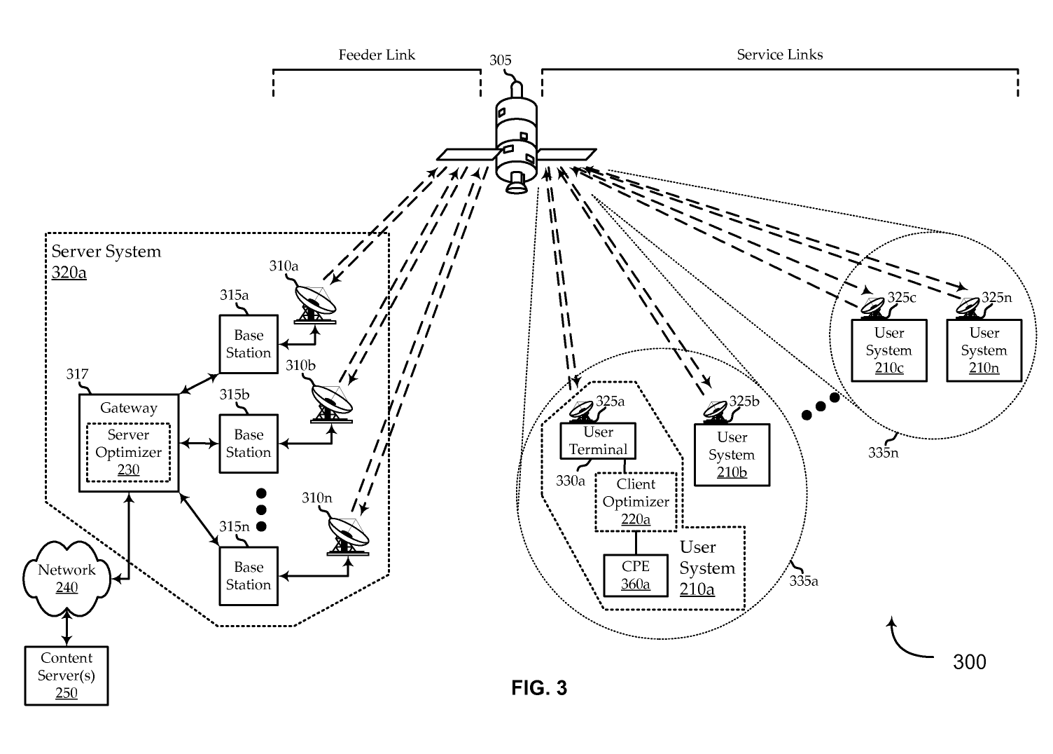

As described below, the server optimizer 230 may be part of a server system 320 that includes components for server-side communications (e.g., base stations, gateways, satellite modem termination systems (SMTSs), digital subscriber line access multiplexers (DSLAMs), etc., as described below with reference to FIG. 3). The server optimizer 230 may act as a transparent and/or intercepting proxy. For example, the client optimizer 220 is in communication with the server optimizer 230 over a client-server communication link 225, and the server optimizer 230 is in communication with the content server 250 over a content network link 235. The server optimizer 230 may act as a transparent man-in-the-middle to intercept the data as it passes between the client-server communication link 225 and the content network link 235. Further, embodiments of the server optimizer 230 maintain a server dictionary 234 (e.g., like the receiver dictionary 144 of FIG. 1) including byte sequences of some or all of the traffic previously seen by the server optimizer 230.

For example, when the user system 210 downloads content from the content server 250, the server optimizer 230 may intercept the content and store blocks of content data in the server dictionary 234. The content may then be sent (e.g., over the client-server communication link 225) to the user terminal 210 in response to the user's request for the content. The client optimizer 220 intercepts the traffic at the client side of the optimizer tunnel 205 and generates a digest of the content, as described above. The digest is stored in a server dictionary model 224. In some embodiments, additional data (e.g., fingerprints) are generated to facilitate efficient searches for the digests in the server dictionary model 224. For example, the digest may be a strong identifier that can reliably represent an identical data block stored at the server dictionary 234, and a weak identifier (e.g., a hash) may be generated for quickly finding matching candidates among a large set of digests.

In the event that the content is later uploaded to the communications system 200a, the client optimizer 220 may intercept the upload (e.g., the request may be directed or redirected to the client optimizer 220) and look for a match in the server dictionary model 224, indicating presumptive existence of the upload content on the server dictionary 234. If a match is found, a highly compressed version of the content may be communicated to the server system 320 over the client-server communication link 225. For example, the highly compressed version may use the matching digests or other identifiers (e.g., block IDs) from the server dictionary model 224 as indexes to recreate the content at the server-side from byte sequences stored in the server dictionary 234.

It is worth noting that the upload may not be ultimately destined for the server system 320. For example, in a peer-to-peer context, the upload may actually be from one user system 210 to another user system 210. While the communications system 200a illustrated in FIG. 2A shows only one optimizer tunnel 205 between one server system 320 and one user system 210, embodiments typically operate in the context of, and take advantage of, optimization among multiple user systems 210. FIG. 2B shows a simplified block diagram of an embodiment of a communications system 200b having multiple user systems 210 for use with various embodiments. The communications system 200b facilitates communications between a server system 320 and multiple user systems 210, via a respective server optimizer 230 and at least one client optimizer 220.

As described above with reference to FIG. 2A, a first user system 210a may desire to upload content after a previous download of the content from the server system 320. Using the client optimizer 220, the server optimizer 230, the server dictionary 234, and the server dictionary model 224, return-link bandwidth may be optimized for this scenario. Notably, the optimized return-link bandwidth may refer to the return link between the first user system 210a and the server system 320, regardless of the ultimate destination of the upload content. For example, the return link may be optimized even where the ultimate destination of the content is the second user system 210n, such that the content is further communicated from the server system 320 to other nodes of the communications system 200b.

Further, it is worth noting that embodiments may optimize the return-link bandwidth, regardless of whether the ultimate destination terminal includes optimization functionality. For example, some embodiments of the second user system 210n include a second client optimizer 220n that is in communication with the server optimizer 230 and maintains its own server dictionary model 224n. In other embodiments, however, the second client optimizer 220n may be any receiving node anywhere on the network, even one having no client optimizer 220n and/or no server dictionary model 224n. For example, the return-link optimization may be effectuated between the first user system 210a and the server system 320 via their respective client optimizer 220 and server optimizer 230, even where the destination for the traffic is some node of the network other than the server system 320.

FIG. 2C describes an embodiment particularly directed to a peer-to-peer file sharing system. For example, in one potential embodiment, the system may be optimized for BitTorrent file sharing. BitTorrent is a widespread peer-to-peer protocol allowing users to download large objects or files rapidly directly from other users. BitTorrent's power lies in the use of a “swarm” of other peer devices that already have the object and make pieces of the object available for upload. A BitTorrent client may use a torrent file to identify the location of standardized pieces of an object on various peer devices in the swarm. By opening multiple TCP connections to other peer devices, a single end user can simultaneously download multiple pieces of the object in parallel. Generally, the end user will also make any pieces already received available for upload to other downloaders also connected to the swarm. BitTorrent's widespread use causes it to take a large amount of bandwidth in many networks, making optimization related to peer-to-peer file transfer a valuable benefit. Additional details of embodiments specifically related to BitTorrent are included below.

FIG. 2C includes first user device 211, client-side proxy 221, server-side proxy 321, network 240, tracking server computer 299, communication link 225, communication link 227, network link 237a, network link 237b, and peer second user device 215. The system of FIG. 2C may be similar to the embodiments described in FIGS. 2A, 2B, and 3, except that the peer second user device 215 may function in place of or in conjunction with a content server when first user device 211 requests an object, and first user device 211 may function in place of or in conjunction with a content server when peer second user device 215 requests an object.

First user device 211 may be similar to user machine 114 or user machine 214. First user device 211 includes interface 213, which may include hardware, software, and firmware for communicating with client-side proxy 221. First user device also includes peer-to-peer file transfer client 290 and object piece storage 290.

Peer-to-peer file transfer client 290 operates as a module of first user device 211, and may operate to implement peer-to-peer file sharing. Peer-to-peer file transfer client 290 manages objects being uploaded and downloaded in communication with other peer devices, and may manage storage of objects or pieces of objects in object piece storage 290a. A BitTorrent client may be one potential example of a peer-to-peer file transfer client 290, with standardized pieces of objects stored in object piece storage 290a.

In certain embodiments, then, peer-to-peer file transfer client 290 is simply a program that runs on first user device 211. In the case of a BitTorrent client, the client takes in a torrent file, finds the swarm via a provided tracker in the file, and then performs a simple, efficient handshake with peer devices in the swarm (“seeders”) in order to begin transmission. First user device 211 operating peer-to-peer file transfer client 290 is thus a “local” client, which refers to a single client installed by a user with object pieces communicated to and from object piece storage 290a.

Client-side proxy 221 may be similar to client optimizer 220 or optimizers 120 and 140, while client-side proxy 221 is shown in FIG. 2C as a device such as a modem device separate from first user device 211. In other embodiments, client-side proxy 221 may be a module operating as part of first user device 211. In addition to other potential functionality, client-side proxy 221 may intercept, interpret, and compress data passing between the peer-to-peer file transfer client 290 and server-side proxy 321. The client-side proxy 221 may thus intercept upstream data from a local user device 221 as it is attempting to send to the peer systems. First user device 221 is thus again referred to as the “local” device with other “external” or “peer” clients not participating in compression or caching associated with the local client.

Peer second user device 215 is then another device operating a peer-to-peer file transfer client that is compatible with peer-to-peer file transfer client 290. Although a single peer second user device 215 is shown, and number of client-side peer devices may be part of a system. Additionally, in certain embodiments, a peer-to-peer file transfer client may communicate with both client-side peers and a server-side content server computer to download pieces of a single object from both client-side peers and server-side sources simultaneously, serially, or in any combination.

Server-side proxy 321 may be similar to server system 320. Server-side proxy 321 may include one or more server computers, and may be implemented in any combination of hardware, software and firmware. As shown in FIG. 2C, server-side proxy 321 includes server optimizer 230 and server-side object piece storage 235. In addition to or in place of any other functionality described herein for a server optimizer 230, a server optimizer 230 may function to identify a peer-to-peer protocol associated with a communication received by server-side proxy 321. Caching and storage particularly tailored to the identified peer-to-peer protocol may be applied to the communication or future copies of the communication identified as part of system functions.

In certain embodiments, server-side proxy 321 may be a server computer through which all communications to and from first user device 211 will be routed through. Server-side proxy 321 may be connected to a data storage system with a large capacity such as server-side object piece storage 235. In various embodiments, server-side object piece storage 235 may be a local memory as part of the server computer comprising server-side proxy 321. In other embodiments, one or more separate memory devices or servers with database or other memory functionality may be coupled to server optimizer 230 via a network to implement server-side object piece storage 235. Server-side object piece storage 235 is then used for caching of peer-to-peer traffic. A client-side proxy 221 may communicate with server-side proxy 321 to identify objects or pieces of objects stored in server-side object piece storage 235.

When the client-side proxy 221 intercepts an outbound block from the first user device 221, knowledge that a piece of the object from the intercepted communication enables the client-side proxy 221 to compress the communication. The server-side proxy 321 may then decompress the information with the copy of the object piece from server-side object piece storage 235, and the server-side proxy 321 may thus essentially send out the corresponding object piece that it has already cached. This saves the user device from needing to upload full object piece and greatly reduces usage of communication link 225.

As mentioned above, a peer-to-peer file transfer client 290 may not inherently know where to begin looking for object or pieces of objects to download. Various centralized and distributed methods may be available for identifying peer devices in a swarm having pieces of an object available for download by first user device 211. In the embodiment of FIG. 2C, first user device 211 may communicate with tracking server computer 299 to receive information related to the network location of peers such as peer second user device 215. For example, in one potential embodiment, a torrent file may direct peer-to-peer file transfer client 290 to tracking server computer 299. Tracking server computer 299 may be a server computer accessible at a web addresses that may track various users in the swarm including peer second user device 215. When first user device 211 wishes to join a swarm, it may contact tracking server computer 299, which will in turn provide peer-to-peer file transfer client 290 with a list of available peers including peer second user device 215. Peer-to-peer file transfer client 290 may then contact peers such as peer second user device 215 using a list from tracking server computer 299 to connect with and verify peers for data transmission.

First user device 211 may then contact peer second user device 215 to download a first object piece. Peer second user device 215 will communicate the first object piece to the first user device 211 via server-side proxy 321. When server-side proxy 321 receives the first object piece as part of this transmission, it may verify that it has a copy of the first object piece in server-side object piece storage 235 and store a copy if one is not already present.

Later, when another peer device identifies first user device 211 as a source which is available to upload the first object piece, either via a list from tracking server computer 299 or some other means, the peer may send a request to first user device 211 for the first user piece. Server optimizer 230 may intercept this request, and identify that the request is associated with the first object piece that is stored in server-side object piece storage 235. Server-side proxy 321 will forward the request from the peer to the first user device 211, and may also then send a message to client-side proxy 211 with information that a copy of the first object piece is in the server-side object piece storage 235.

When peer-to-peer file transfer client 290 responds to the request for the piece of the first object stored in object piece storage 290a, client-side proxy 221 may intercept this request. Then, rather than uploading the entire first object piece, the client-side proxy may use compression, such as dictionary compression or any other acceptable compression relying on the copy of the first object piece stored in server-side object piece storage 235, to compress the piece of the object and send the response to server-side proxy 321. When server-side proxy 321 receives the communication from client-side proxy 221, it may decompress the first piece of the object using the copy from server-side object piece storage 235, and communicate the first object piece to the requesting peer.

In certain embodiments, one potential benefit of such a system may be that the compression is completely transparent to peer-to-peer file transfer client 290 and the compatible client on a peer device that requested the first piece of the object. This allows updates and optimizations to be implemented in the various clients without the compression functionality breaking the operation of the peer-to-peer file transfer system. Further, this prevents the server-side proxy 321 from replacing one of the peers in the peer-to-peer communication process. Instead, the server-side proxy 321 is simply using dictionary information in server-side object piece storage 235 to reduce usage of communication link 225.

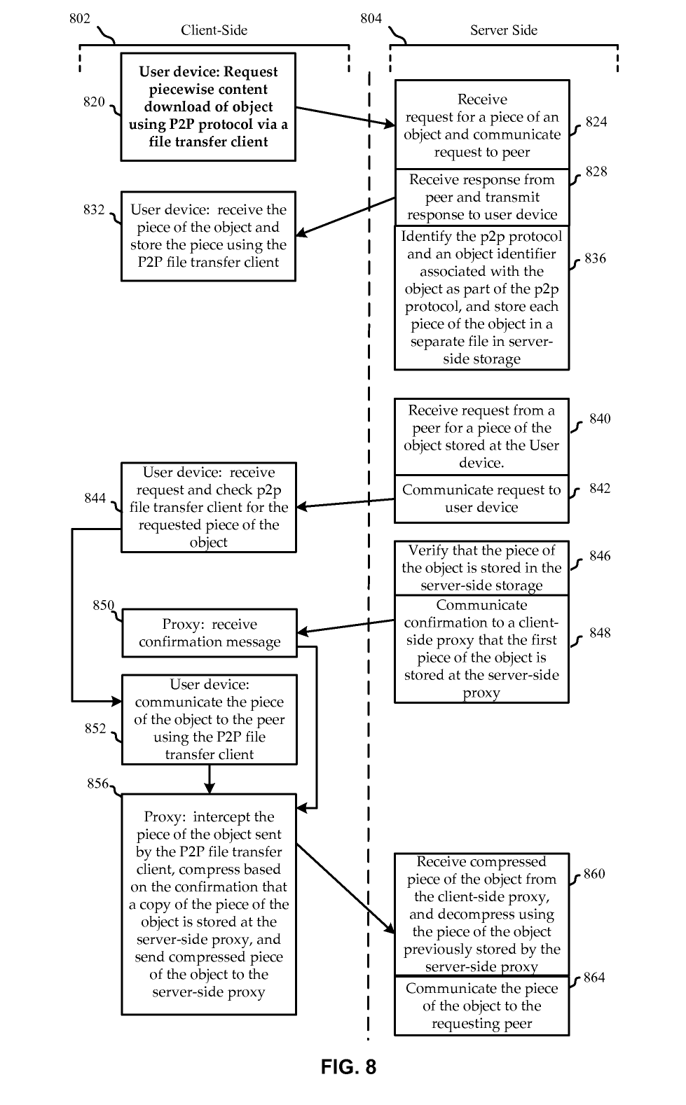

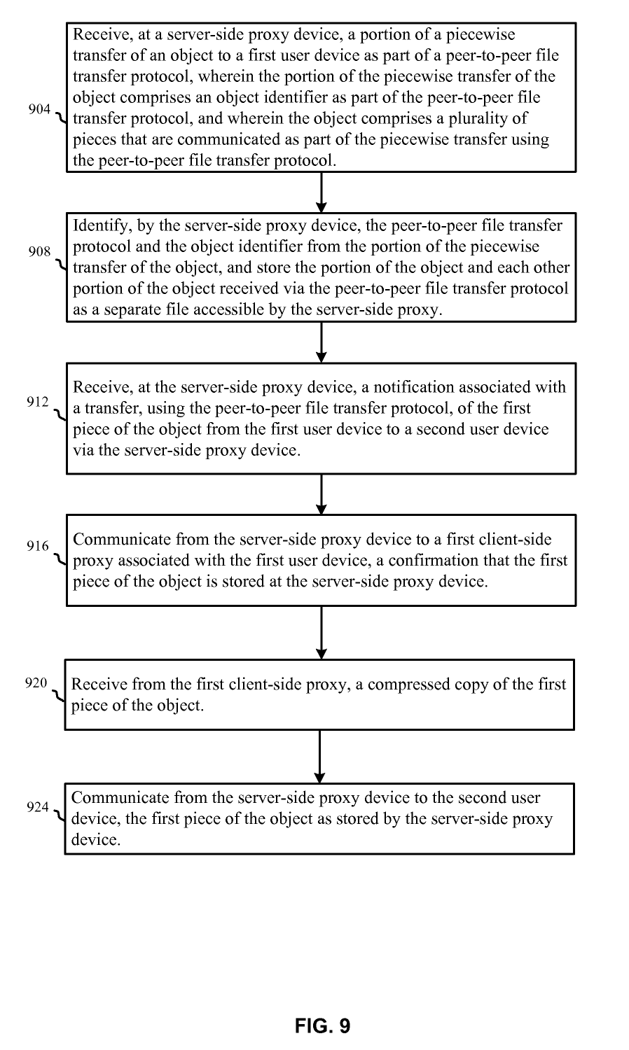

For a peer-to-peer protocol such as BitTorrent which includes a standard system for breaking objects into pieces and communicating the pieces rather than entire objects, this also allows an embodiment of FIG. 2C to store pieces of an object as separate files so that the information stored in server-side object piece storage 235 comprises separate files which are not able to be used or consumed as media without additional functionality to merge the separate files into the original object. In embodiments where server-side proxy 321 does not have this functionality, issues related to caching and transfer of the original object may be avoided in certain circumstances. Further details of a peer-to-peer system with uplink compression and specific details related to systems optimized for BitTorrent will be described in additional detail below with respect to FIGS. 8 and 9.

FIGS. 1, 2A, 2B, and 2C illustrate various types of communications systems for use with embodiments of the invention using generic component designations. It will be appreciated that these components may be implemented in various nodes of various types and topologies of communications systems. For example, the communications systems may include cable communications systems, satellite communications systems, digital subscriber line (DSL) communications systems, local area networks (LANs), wide area networks (WANs), etc. Further, the links of the communications systems may include wired and/or wireless links, Ethernet links, coaxial cable links, fiber-optic links, etc. Some embodiments include shared portions of the forward and/or reverse links between nodes (e.g., a shared spot beam in a satellite communications system), while other embodiments include unshared links between nodes (e.g., in an Ethernet network).

In one illustrative example, FIG. 3 shows a block diagram of an embodiment of a satellite communications system 300 having a server system 320 in communication with multiple user systems 210 via a satellite 305 over multiple spot beams 335, according to various embodiments. The server system 320 may include any server components, including base stations 315, gateways 317, etc. A base station 315 is sometimes referred to as a hub or ground station. In certain embodiments, the base station 315 has functionality that is the same or different from a gateway 317. For example, as illustrated, a gateway 317 provides an interface between the network 240 and the satellite 305 via a number of base stations 315. Various embodiments provide different types of interfaces between the gateways 317 and base stations 315. For example, the gateways 317 and base stations 315 may be in communication over leased high-bandwidth lines (e.g., raw Ethernet), a virtual private large-area network service (VPLS), an Internet protocol virtual private network (IP VPN), or any other public or private, wired or wireless network. Embodiments of the server system 320 are in communication with one or more content servers 250 via one or more networks 240.

As traffic traverses the satellite communications system 300 in multiple directions, the gateway 317 may be configured to implement multi-directional communications functionality. For example, the gateway 317 may send data to and receive data from the base stations 315. Similarly, the gateway 317 may be configured to receive data and information directed to one or more user systems 210, and format the data and information for delivery to the respective destination device via the satellite 305; or receive signals from the satellite 305 (e.g., from one or more user systems 210) directed to a destination in the network 240, and process the received signals for transmission through the network 240.

In various embodiments, one or more of the satellite links are capable of communicating using one or more communication schemes. In various embodiments, the communication schemes may be the same or different for different links. The communication schemes may include different types of coding and modulation combinations. For example, various satellite links may communicate using physical layer transmission modulation and coding techniques using adaptive coding and modulation schemes, etc. The communication schemes may also use one or more different types of multiplexing schemes, including Multi-Frequency Time-Division Multiple Access (“MF-TDMA”), Time-Division Multiple Access (“TDMA”), Frequency Division Multiple Access (“FDMA”), Orthogonal Frequency Division Multiple Access (“OFDMA”), Code Division Multiple Access (“CDMA”), or any number of other schemes.

The satellite 305 may operate in a multi-beam mode, transmitting a number of spot beams 335, each directed at a different region of the earth. Each spot beam 335 may be associated with one of the user links, and used to communicate between the satellite 305 and a large group (e.g., thousands) of user systems 210 (e.g., user terminals 330 within the user systems 210). The signals transmitted from the satellite 305 may be received by one or more user systems 210, via a respective user antenna 325. In some embodiments, some or all of the user systems 210 include one or more user terminals 330 and one or more CPE devices 360. User terminals 330 may include modems, satellite modems, routers, or any other useful components for handling the user-side communications. Reference to “users” should be construed generally to include any user (e.g., subscriber, consumer, customer, etc.) of services provided over the satellite communications system 300 (e.g., by or through the server system 320).

In a given spot beam 335, some or all of the users (e.g., user systems 210) serviced by the spot beam 335 may be capable of receiving all the content traversing the spot beam 335 by virtue of the fact that the satellite communications system 300 employs wireless communications via various antennae (e.g., 310 and 325). However, some of the content may not be intended for receipt by certain customers. As such, the satellite communications system 300 may use various techniques to “direct” content to a user or group of users. For example, the content may be tagged (e.g., using packet header information according to a transmission protocol) with a certain destination identifier (e.g., an IP address), use different modcode points that can be reliably received only by certain user terminals 330, send control information to user systems 210 to direct the user systems 210 to ignore or accept certain communications, etc. Each user system 210 may then be adapted to handle the received data accordingly. For example, content destined for a particular user system 210 may be passed on to its respective CPE 360, while content not destined for the user system 210 may be ignored. In some cases, the user system 210 caches information not destined for the associated CPE 360 for use if the information is later found to be useful in avoiding traffic over the satellite link, as described in more detail below.

Embodiments of the server system 320 and/or the user system 210 include an accelerator module and/or other processing components. In one embodiment, real-time types of data (e.g., User Datagram Protocol (“UDP”) data traffic, like Internet-protocol television (“IPTV”) programming) bypass the accelerator module, while non-real-time types of data (e.g., Transmission Control Protocol (“TCP”) data traffic, like web video) are routed through the accelerator module for processing. Embodiments of the accelerator module provide various types of applications, WAN/LAN, and/or other acceleration functionality.

In some embodiments, the accelerator module is adapted to provide high payload compression. This allows faster transfer of the data and enhances the effective capacity of the network. The accelerator module can also implement protocol-specific methods to reduce the number of round trips needed to complete a transaction, such as by prefetching objects embedded in HTTP pages. In other embodiments, functionality of the accelerator module is closely integrated with the satellite link through other modules, including the client optimizer 220 and/or the server optimizer 230.

As discussed above, the satellite communications system 300 may be configured to implement various optimization functions through client-server interactions, implemented by the client optimizer 220 and the server optimizer 230. The server optimizer 230 may be configured to maintain a server dictionary and the client optimizer 220 may be configured to maintain a model of the server dictionary. Embodiments of the client optimizers 220 and server optimizer 230 may act to create a virtual tunnel between the user systems 210 and the content servers 250 or the server system 320, as described with reference to FIGS. 2A and 2B. In a topology, like the satellite communications system 300 shown in FIG. 3, vast amounts of traffic may traverse various portions of the satellite communications system 300 at any given time. The optimizer functionality may help relieve the satellite communications system 300 from traffic burdens relating to file sharing and similar transactions (e.g., by optimizing return-link resources). This and other functionality of the client optimizer 220 and the server optimizer 230 are described more fully with reference to FIG. 4.

FIG. 4 shows a block diagram of an embodiment of a communications system 400, illustrating client-server interactivity through a client optimizer 220 and a server optimizer 230, according to various embodiments. In some embodiments, the communications system 400 is an embodiment of the communications system 200a of FIG. 2A or the satellite communications system 300 of FIG. 3. As shown, the communications system 400 facilitates communications between a user system 210 and one or more content servers 250 via at least one client-server communication link 225. For example, interactions between the client optimizer 220 and the server optimizer 230 effectively create an optimizer tunnel 205 between the user system 210 and the content servers 250. In some embodiments, the server system 320 is in communication with the content servers 250 via one or more networks 240, like the Internet.

In some embodiments, the user system 210 includes a client graphical user interface (GUI) 410, a web browser 406, and a redirector 408. The client GUI 410 may allow a user to configure performance aspects of the user system 210 (e.g., or even aspects of the greater communications system 400 in some cases). For example, the user may adjust compression parameters and/or algorithms, alter content filters (e.g., for blocking illicit websites), or enable or disable various features used by the communications system 400. In one embodiment, some of the features may include network diagnostics, error reporting, as well as controlling, for example, components of the client optimizer 220 and/or the server optimizer 230.

In one embodiment, the user selects a universal recourse locator (URL) address through the client GUI 410 which directs the web browser 406 (e.g., Microsoft® Internet Explorer® ², Mozilla® Firefox® ³, Netscape Navigator® ⁴, etc.) to a website (e.g., cnn.com, google.com, yahoo.com, etc.). The web browser 406 may then issue a request for the website and associated objects to the Internet. It is worth noting that the web browser 406 is shown for illustrative purposes only. While embodiments of the user system 210 may typically include at least one web browser 406, user systems 210 may interact with content servers 250 in a number of different ways without departing from the scope of the invention (e.g., through downloader applications, file sharing applications, applets, etc.).

The content request from the user system 210 (e.g., download request from the web browser 406) may be intercepted by the redirector 408. It is worth noting that embodiments of the redirector 408 are implemented in various ways. For example, embodiments of the redirector 408 are implemented within a user modem as part of the modem's internal routing functionality. The redirector 408 may send the request to the client optimizer 220. It is worth noting that the client optimizer 220 is shown as separate from the user machine 214 (e.g., in communication over a local bus, on a separate computer system connected to the user system 210 via a high speed/low latency link, like a branch office LAN subnet, etc.). However, embodiments of the client optimizer 220 are implemented as part of any component of the user system 210 in any useful client-side location, including as part of a user terminal, as part of a user modem, as part of a hub, as a separate hardware component, as a software application on the user machine 214, etc.

In some embodiments, the client optimizer 220 includes a request manager 416. The request manager 416 may be configured to perform a number of different processing functions, including Java® ⁵ parsing and protocol processing. Embodiments of the request manager 416 may process hypertext transfer protocol (HTTP), file transfer protocol (FTP), various media protocols, metadata, header information, and/or other relevant information from the request data (e.g., packets) to allow the client optimizer 220 to perform its optimizer functions. For example, the request may be processed by the request manager 416 as part of identifying opportunities for optimizing return-link resources for previously downloaded content.

The request manager 416 may forward the request to a request encoder 418. Embodiments of the request encoder 418 encode the request using one of many possible data compression or similar types of algorithms. For example, strong identifiers and/or weak identifiers may be generated using dictionary coding techniques, including hashes, checksums, fingerprints, signatures, etc. As described below, these identifiers may be used to identify digests in a server dictionary model 224 indicating matching data blocks in a server dictionary 234 in, or in communication with, the server optimizer 230.

In some embodiments, the request manager 416 and/or the request encoder 418 process the request content differently, depending on the type of data included in the request. For example, the content portion (e.g., byte-level data) of the data may be processed according to metadata. Some types of schema-specific coding are described in U.S. Provisional Patent Application No. 61/231,265, entitled “METHODS AND SYSTEMS FOR INTEGRATING DELTA CODING WITH SCHEMA SPECIFIC CODING” (026841-002300US), filed on Aug. 4, 2009, which is incorporated herein by reference in its entirety for all purposes.

In some embodiments, the request may be forwarded to a transport manager 428a. In one embodiment, the transport manager 428a implements Intelligent Compression Technologies Inc. (“ICT”) transport protocol (“ITP”). Nonetheless, other protocols may be used, such as the standard transmission control protocol (“TCP”). In one embodiment, ITP maintains a persistent connection with the server system 320 via its server optimizer 230. The persistent connection between the client optimizer 220 and the server optimizer 230 may enable the communications system 400 to eliminate or reduce inefficiencies and overhead costs associated with creating a new connection for each request.

In one embodiment, the encoded request is forwarded from the transport manager 428a in the client optimizer 220 to a transport manager 428b in the server optimizer 230 to a request decoder 436. The request decoder 436 may use a decoder which is appropriate for the encoding performed by the request encoder 418. The request decoder 436 may then transmit the decoded request to a content processor 442 configured to communicate the request to an appropriate content source. For example, the content processor 442 may communicate with a content server 250 over a network 240. Of course, other types of content sources are possible. For example, some or all of the data blocks that make up the requested content may be available in the server dictionary 234. As discussed above, embodiments of the server dictionary 234 include indexed blocks of content data (e.g., byte sequences).

In response to the request, response data may be received by the content processor 442. For example, the response data may be retrieved from an appropriate content server 250, from the server dictionary 234, etc. The response data may include various types of information, such as one or more attachments (e.g., media files, text files, etc.), references to “in-line” objects needed to render a web page, etc. Embodiments of the content processor 442 may be configured to interpret the response data, which may, for example, be received as HTML, XML, CSS, Java Scripts, or other types of data. In some embodiments, when response data is received, the content processor 442 checks the server dictionary 234 to determine whether the content is already stored by the server system 230. If not, the content may be stored to the server dictionary 234.

In some embodiments, the response received at the content processor 442 is parsed by a response parser 444 and/or encoded by a response encoder 440. The response data may then be communicated back to the user system 210 via the protocol managers 428 and the client-server communication link 225. After the response data is received at the client optimizer 220 by its transport manager 428a, the response data is forwarded to a response manager 424 for client-side processing.

Embodiments of the response manager 424 generate a strong identifier (e.g., a digest) of the response data for storage in the server dictionary model 224. For example, certain embodiments assume that response data is stored in the server dictionary 234 (i.e., the response data was stored either prior to or upon receipt by the content processor 442 in the server optimizer 230. As such, it may be assumed by embodiments of the client optimizer 220 that the server dictionary model 224 is, in fact, a model of the server dictionary 234 without requiring any explicit messages from the server optimizer 230 to that effect. It is worth noting that, in some embodiments, synchronization techniques are used to ensure that the server dictionary model 224 remains an accurate model of the server dictionary 234. For example, the server optimizer 230 may desire to remove a data block from its server dictionary 234. The server optimizer 230 may notify the client optimizer 220 that is it ready to remove the data block, wait for a notification back from the client optimizer 220 confirming deletion of the data block from the server dictionary model 224, and then remove the data block from the server dictionary 234.

In certain embodiments, the response manager 424 may further generate a weak identifier (e.g., a checksum, a hash, etc.). The weak identifier may be used to quickly find strong identifier entries in the server dictionary model 224, as described more fully below. Once the server dictionary model 224 is updated, the response manager 424 may forward the response data to the user machine 214 (e.g., via its redirector 408).

At some later time, a user desires to upload the same content that was previously downloaded (referred to as “upload-after-download”). For example, the upload-after-download may occur as part of a file sharing transaction. It is worth noting that the upload-after-download content may be either identical to or different from the originally downloaded content; and where the upload-after-download content is different, it may differ in varying degrees. For example, a user may download a document, modify the document, and re-upload the modified document. Depending on the amount of modification, the upload-after-download content (i.e., the re-uploaded, modified document) may be slightly or significantly different (e.g., at the byte level) from the downloaded version of the document.

When the user uploads the content in the upload-after-download context, the upload request may be intercepted by the redirector 408 and sent to the client optimizer 220. The request manager 416 in the client optimizer 220 parses the upload request to find any object or other content data that should be evaluated for optimization. The parsed data may then be encoded by the request encoder 418 to generate one or more identifiers associated with the content requested for upload.

In some embodiments, the request encoder 418 generates a weak identifier (e.g., by applying a hashing function). The weak identifier is then used to quickly find candidate matches for the content among the digests stored in the server dictionary model 224. As noted above, when matches are found, embodiments of the client optimizer 220 assume that the content (e.g., or data blocks needed to decompress a compressed version of the content) are presently stored in the server dictionary 234). If matches are found, the matching digests may be used to generate a highly compressed version of the upload content. The highly compressed version of the upload content may then be uploaded to the server system 320 for decompression and/or further processing.

It is worth noting that strong and weak identifiers, as used herein, may be generated in different ways according to different functions. In some embodiments, received data block are of variable size. The boundaries of the blocks are established, for example, by a function that operates on N bytes. Each time the output of this function has a particular value, a boundary is established. If the value of the function does not match the particular value, the block position may be advanced by one byte and a new function output may be calculated. For computational efficiency, certain embodiments of the function include a rolling checksum or other algorithm that allows the function value to be adjusted as a new byte is added and an old byte is removed from the set of N bytes used to compute the function. This approach may allow the same block boundaries to be established even when starting at different points in a stream (e.g., a session stream).

The boundary points may delimit blocks of variable sizes, and a strong identifier can then be calculated on each block delimited in this way (e.g., using a Message-Digest algorithm 5 (MD5) technique, or other technique). When a boundary point is reached, the strong identifier of the completed block can be compared against the identifiers in the server dictionary model 224 to see if the new block matches data in the server dictionary 234. Other techniques for delimiting blocks and identifying matching with previous blocks are possible.

In one illustrative embodiment, a byte sequence is received as a stream of data. For each N bytes, a rolling checksum is calculated, for example, according to the equation:

$$( {\sum }_{i = 0}^{N - 1} f ( x , i ) ) mod M .$$

According to this equation, “i” is the position of a byte in the sequence, so that i=0 for the first byte in the block and i=N−1 for the last byte in the block. Also according to the equation, “x” is the value of the byte at position i, which may, for example, be in the range 0-255. Further according to the equation, “f(x,i)” is a function applied to each entry. For example, the function may use x as an index into an array of prime values “P,” which may be multiplied by the local offset i, so that f(x,i)=P[x]*i. And further, according to the equation, modulo arithmetic can be applied to the total, so that the number of possible output values is the modulo value. Adjusting the modulus may then adjust the average size of the output blocks, as it sets the probability that a match with the special value S (e.g., the “particular value” discussed above) will occur at any point, where S is any value between 0 and M-1. Each time the sum equals the special value S, a boundary point is established in the incoming stream. Each pair of boundary points may define a dictionary block, and a strong identifier is calculated on each such block. The rolling checksum function is applied to every block of N bytes in the incoming stream.

In one example, a user engages in file sharing by downloading a one-Megabyte content file and then becoming a source (e.g., a server) for that content file, uploading the file multiple times. Without return-link optimization, the entire one-Megabyte of file data may be re-uploaded with each upload request. Using the client optimizer 220, however, the return-link bandwidth usage may be minimized. For example, the digests in the server dictionary model 224 may provide 10,000-to-1 compression, such that the one-Megabyte file can be compressed into only one-hundred bytes of digest data. As such, even multiple upload requests may be compressed into only hundreds or thousands of bytes of total bandwidth usage on the return link.

Notably, as the optimization occurs on the return link from the client optimizer 220 to the server optimizer 230, the optimization may be unaffected by destinations for the upload content beyond the server system 320. For example, the upload from the user system 210 via the client optimizer 220 may be destined for another user system 210 in communication with the server system 320. As discussed above, the optimization may be unaffected by a presence or absence of a client optimizer 220 at the destination user system 210.

Further, it is worth noting that the digest-based optimization may provide optimization benefits (e.g., compression), even where portions of a content file have changed. For example, in a collaborative media editing environment, revisions of large media files may be sent back and forth among a number of users. When each revision upload is intercepted by a client optimizer 220, the server dictionary model 224 may include digests for the unchanged data blocks. As such, those unchanged blocks may still be sent in highly compressed form, while the changes are sent in uncompressed form (e.g., or, at least, not compressed according to the server dictionary model 224). Upon receipt at the server optimizer 230, the server dictionary 234 may then be used to decompress the compressed blocks of the upload and/or updated with the uncompressed revision data.

The communications system 400 illustrated in FIG. 4 shows a client optimizer 220 having storage only for a server dictionary model 224. Embodiments of the client optimizer 220 shown in FIG. 4 may have no access (e.g., or no practical or efficient access) to other storage capacity. For example, the client optimizer 220 may not be authorized to access the machine storage 218 and/or may not have additional capacity of its own (e.g., for storage of its own dictionary or for a cache). However, in other embodiments, the client optimizer 220 has additional capacity, which it may manage according to whether return-link optimization is desired.

FIG. 5 shows a block diagram of an embodiment of a client optimizer 220 having additional storage capacity and mode selection, according to various embodiments. As in the client optimizer 220 of FIG. 4, the client optimizer 220a of FIG. 5 includes a request manager 416, a request encoder 418, a response manager 424, a transport manager 428, and a server dictionary model 224. However, the client optimizer 220a of FIG. 5 also includes a client dictionary 524, a mode selector 520, and file sharing detectors 510. Embodiments of the client optimizer 220a operate in a “file sharing” operating mode when file sharing content (e.g., or any content deemed a likely upload-after-download candidate) is detected and in a “normal” mode for other types of traffic, as described below.

When the user downloads content from the server system 320, the content is received via the transport manager 428 by the client optimizer 220. The received content is evaluated by the file sharing detector 510 to determine whether the content includes file sharing content. As discussed above, “file sharing” content is used herein to describe any traffic having a probability of being uploaded after download. This determination can be made in a number of ways. For example, metadata may be evaluated to look for certain file sharing protocols, certain types of content (e.g., file types) may be deemed more likely to be re-uploaded, patterns of use may be evaluated to find upload-after-download candidates, etc.

The determination of the file sharing detector 510 may be used to set the operating mode of the client optimizer 220a for handling that content, and the response manager 424 may process the content according to that operating mode. In some embodiments, if the file sharing detector 510 determines that the content includes file sharing content, the mode selector 520 may be set such that the client optimizer 220a processes the content in “file sharing” operating mode. For example, the file sharing content may be processed as described above with reference to FIG. 4. The response manager 424 may generate one or more identifiers (e.g., digests) for storage in the server dictionary model 224, and may pass the content to the user machine 214.

If the file sharing detector 510 determines that there is no file sharing content, the mode selector 520 may be set such that the client optimizer 220a processes the content in “normal” operating mode. According to the normal operating mode, the content may be processed in a number of ways, including using the client dictionary 524 for various types of optimization. In one embodiment, the normal operating mode exploits deltacasting opportunities, as described in U.S. patent application Ser. No. 12/651,909, entitled “DELTACASTING” (Attorney Docket No. 81094-763171 (019510US)), filed on Jan. 4, 2010, which is incorporated herein by reference in its entirety for all purposes. In other embodiments, the normal operating mode configures the client optimizer 220a to implement functionality of delta coders, caches, and/or other types of network components known in the art.

When the user uploads content from the user machine 214, the upload request may be sent to the client optimizer 220. The request manager 416 in the client optimizer 220 processes (e.g., parses) the upload request to find any object or other content data that should be evaluated for optimization. In some embodiments, the parsed data is then encoded by the request encoder 418 to generate one or more identifiers associated with the content requested for upload. The identifiers may then be evaluated against one or both of the server dictionary model 224 and the client dictionary 524 to find and/or exploit matches.

In other embodiments, information obtained from processing the upload request is used by the file sharing detector 510 to determine whether the upload request includes file sharing traffic. The operating mode may then be selected by the mode selector 520 and the upload request may be encoded by the request encoder 418 according to the determination of the file sharing detector 510. For example, if the file sharing detector 510 detects file sharing content, the mode selector 520 may select the “file sharing” operating mode. In this mode, the request encoder 418 may generate a weak identifier for use in finding matching digests in the server dictionary model 224 without any reference to the client dictionary 524. As discussed above, any matches found in the server dictionary model 224 may then be used to compress the upload request, for example, for return-link optimization.

It will be appreciated that, while the above descriptions of content transactions focus on requests and responses, these terms are intended to be broadly construed, and embodiments of the invention function within many other contexts. For example, embodiments of the communication system 400 are used to provide interactive Internet services (e.g., access to the world-wide web, email communications, file serving and sharing, etc.), television services (e.g., satellite broadcast television, Internet protocol television (IPTV), on-demand programming, etc.), voice communications (e.g., telephone services, voice-over-Internet-protocol (VoIP) telephony, etc.), networking services (e.g., mesh networking, VPN, VLAN, MPLS, VPLS, etc.), and other communication services. As such, the “response” data discussed above is intended only as an illustrative type of data that may be received by the server optimizer 230 from a content source (e.g., a content server 250). For example, the “response” data may actually be pushed, multicast, or otherwise communicated to the user without an explicit request from the user.

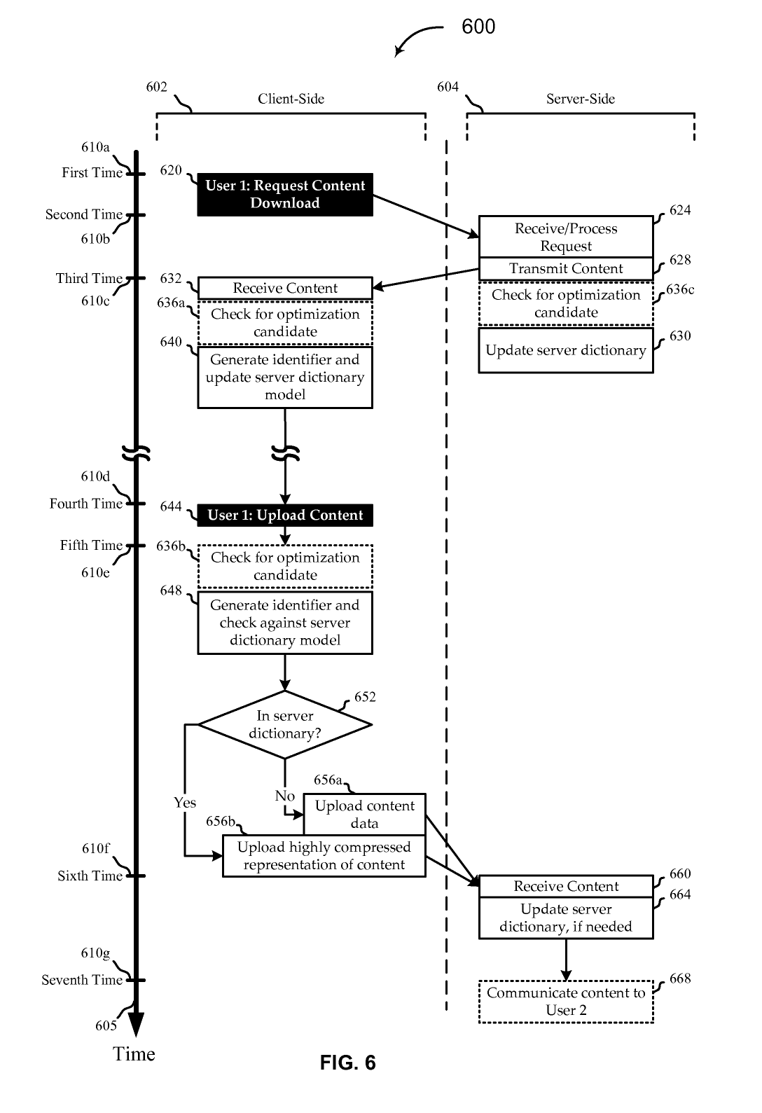

It will be further appreciated that embodiments of systems and components described above include merely some exemplary embodiments, and various methods of the invention can be performed by those and other system embodiments. FIG. 6 shows an illustrative method 600 for performing return-link optimization, according to various embodiments. Particularly, the method 600 illustrates an “upload-after-download” scenario (e.g., a re-upload to the Internet, P2P file sharing of previously downloaded content, etc.). In some embodiments, the method 600 is performed by one or more components of a client optimizer 220, as described above with reference to FIGS. 1-5.

For the sake of added clarity, the method 600 is shown with reference to client-side activities 602 and server-side activities 604, and with reference to illustrative timing on a timeline 605. Of course, certain client-side functions may be performed by server-side components, certain server-side functions may be performed by client-side components, and specific timing of process blocks may be changed without affecting the method 600. Further, it will be appreciated that the timeline 605 is not intended to show any time scale (relative or absolute), and certain process blocks may occur in series, in parallel, or otherwise, according to various embodiments. For at least these reasons, it will be appreciated that these elements of FIG. 6 are intended only for clarity and are not intended to limit the scope of the method 600 in any way.

Some embodiments of the method 600 begin at a first time 610a (shown on timeline 605), when the client-side 602 (e.g., a user of a user machine) requests content for download in block 620. At a second time 610b, (e.g., after some delay due to latency of a satellite communication link, etc.), the server-side 604 receives and processes the request at block 624. At block 628, the server-side 604 transmits the requested content to the requesting client-side 602 in response to the request. In some embodiments, the server-side 604 also determines whether the content represents an optimization candidate at block 636c. For example, the server-side 604 may evaluate the response data to determine whether it includes file sharing content. If the traffic is deemed an optimization candidate (e.g., or in all cases, for example, where a determination is not made at block 636c), the server-side 604 stores the response data in a local dictionary at block 630.

At a third time 610c, the client-side 602 receives the content at block 632. In some embodiments, the client-side 602 determines whether the content represents an optimization candidate at block 636a. Embodiments of the determination may be similar to those made at the server-side 604 in block 636c. For example, the client-side 602 may evaluate the response data to determine whether it includes file sharing content. If the traffic is deemed an optimization candidate, identifiers (e.g., digests) may be generated at block 640 and used to update a server dictionary model at the client-side 602.

Sometime later, at a fourth time 610d, the client-side 602 makes a request at block 644 that involves upload of the content received in block 632. For example, the client-side 602 desires to re-upload the content to the another location on the Internet, share the content with another user via the communication system, etc. In some embodiments, at a fifth time 610e, the upload request is intercepted at block 636b and a determination is made (e.g., as in block 636a) as to whether the upload request includes content relating to an optimization candidate (e.g., file sharing content).

If the upload request includes optimizable content, according to the determination of block 636b, an identifier may be generated at block 648. For example, a weak identifier may be generated by applying a hashing function to the upload content data. At block 652, the identifier is used to find any candidate matches among the digests stored in the server dictionary model. If matches are not found, the content data may be uploaded at block 656a. If matches are found, the matching digests may be used to generate and upload a highly compressed version of the upload content at block 656b.

At a sixth time 610f, (e.g., again after some delay due to latency), the server-side 604 may receive and process the uploaded content at block 660. At block 664, the server dictionary may be updated with any blocks not already in the dictionary. For example, if the content is uploaded at block 656a without digest-based compression, or if some of the blocks of the content were uploaded without digest-based compression due to changes in the file, the server dictionary may be updated at block 664.

In some embodiments, the upload-after-download scenario is part of a peer-to-peer (P2P) file sharing process, or some other process in which the upload is destined for a node of the communications system other than the server-side 604. In embodiments of these transactions, the uploaded content may then be communicated to a destination node at block 668. For example, the content may be pushed to a user at the same or another client-side 602.

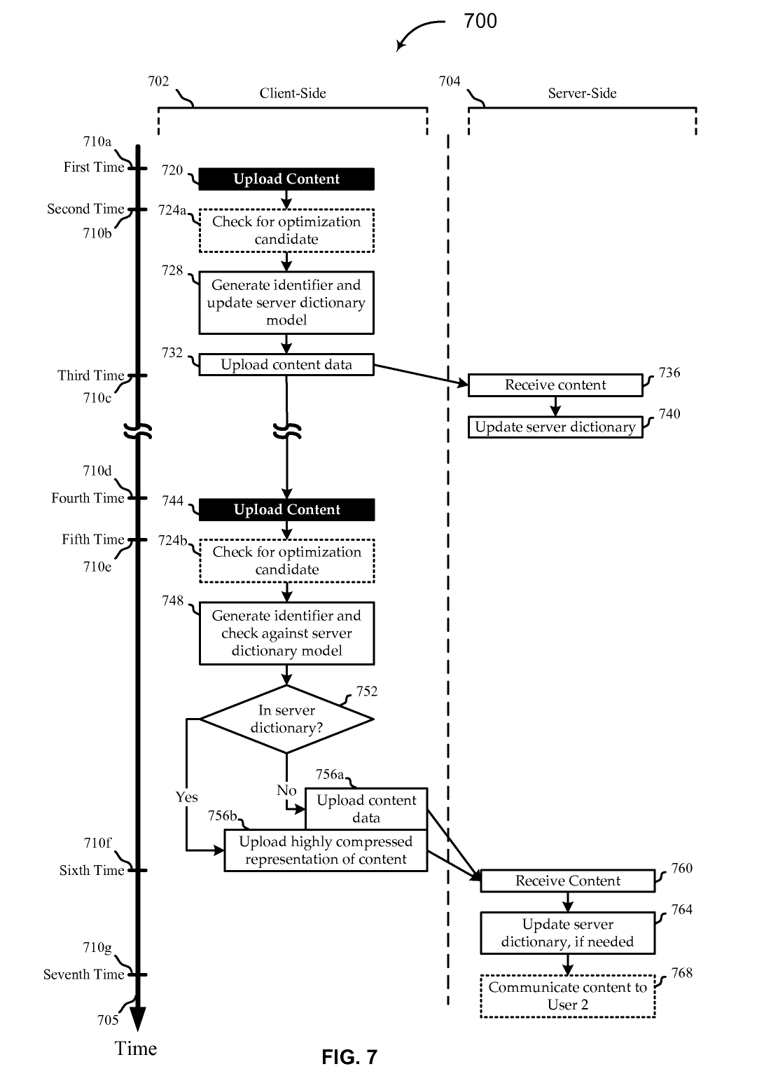

It will be appreciated that various embodiments have been described herein with reference to upload-after-download transactions. However, similar functionality may be used to optimize return-link bandwidth usage in the context of multiple uploads of the same content. FIG. 7 shows an illustrative method 700 for performing return-link optimization for an upload-after-upload transaction, according to various embodiments. As with the method 600 of FIG. 6, the method 700 is shown with reference to client-side activities 702 and server-side activities 704, and with reference to illustrative timing on a timeline 705.

Embodiments of the method 700 begin at a first time 710a (shown on timeline 705), when the client-side 702 (e.g., a user of a user machine) requests upload of content in block 720. At a second time 710b, the upload request is intercepted at block 724a and a determination is made as to whether the upload request includes content relating to an optimization candidate (e.g., file sharing content). If so, an identifier (e.g., a digest) may be generated at block 728 and added to the server dictionary model. For example, it may be assumed that the data will be stored in the server dictionary after it is received by the server-side 704 as part of the present upload request.

The content may then be uploaded at block 732. It is assumed in the illustrative method 700 that this is the first time the content is being uploaded to the server-side 704. At a third time 710c, the uploaded content is received and processed by the server-side 704 at block 736. In some embodiments, at block 740, the server dictionary is updated to reflect the uploaded content.

Sometime later, at a fourth time 710d, the client-side 702 makes a request at block 744 that involves a second upload of the content previously uploaded in block 732. For example, the client-side 702 desires to re-upload the content to another location on the Internet, share the content with another user via the communication system, etc. In some embodiments, at a fifth time 710e, the upload request is intercepted at block 724b and a determination is made (e.g., as in block 724a) as to whether the upload request includes content relating to an optimization candidate (e.g., file sharing content).

If the upload request includes optimizable content, according to the determination of block 724b, an identifier may be generated at block 748. For example, a weak identifier may be generated by applying a hashing function to the upload content data. At block 752, the identifier is used to find any candidate matches among the digests stored in the server dictionary model. If matches are not found, the content data may be uploaded at block 756a. If matches are found, the matching digests may be used to generate and upload a highly compressed version of the upload content at block 756b.

At a sixth time 710f, the server-side 704 may receive and processes the uploaded content at block 760. At block 764, the server dictionary may be updated with any blocks not already in the dictionary. For example, if the content is uploaded at block 756a without digest-based compression, or if some of the blocks of the content were uploaded without digest-based compression due to changes in the file, the server dictionary may be updated at block 764. In some embodiments, the uploaded content may then be communicated to a destination node other than the server-side 704 at block 768.

It is worth noting, that blocks 744, 748, 752, 756a, 756b, 760, 764, and 768 of the method 700 of FIG. 7 may be implemented substantially identically to blocks 644, 648, 652, 656a, 656b, 660, 664, and 668 of the method 600 of FIG. 6, respectively. For example, once content is uploaded once to the server (e.g., either after a download, as in FIG. 6, or not, as in FIG. 7) the data may be used to reduce return-link bandwidth on future uploads of the same content. As such, embodiments of systems and methods described herein handle both upload-after-download and upload-after-upload transactions.

Further, as described above, certain embodiments may be implemented without a client side dictionary or dictionary model. In such embodiments, the flow of FIGS. 6 and 7 will function differently. In such embodiments, peer uploads are always preceded by a request from the downloading user to the uploading user. This upload request, which is always seen by the server optimizer before the uploading peer, will trigger the server optimizer to send an identifier for the requested upload to the client optimizer. The client optimizer will only generate an identifier for an uploaded piece if it has first received a server optimizer-generated identifier to compare against. In this way, the server-generated identifier acts as a “primer” for the client optimizer to generate an identifier. If the server optimizer does not send a generated identifier, then the server does not have a copy of the requested upload, and the client optimizer will have to send the full data upload, uncompressed. This means that blocks 636, 640, 724, and 728 will not take place in such embodiments. Similarly, for such embodiments, blocks 652 and 752 may take place on the server-side 604 and 704 respectively, and take place before blocks 644 and 744 are reached on the client-side 602 and 702.

FIG. 8 describes a method that may operate in accordance with various embodiments, with communications between a client-side 802 and a server-side 804 in a system for optimizing uploads in a peer-to-peer communication system. For example, FIG. 8 may be implemented by the system of FIG. 2C.

In 820, a user device such as user computing device 211 requests a piecewise content download of an object using a peer-to-peer protocol enabled by a file transfer client operating on the user device. The term “piecewise” refers to a communication where an object is broken into separate pieces and the pieces are communicated separately. Such a piecewise transfer may be distinguished from a packetized transfer where packets or other subdivisions of an object have transport data added to enable the communication of the entire object. By contrast in a piecewise transfer, each piece of the object may be communicated as a separate object across the communication and network links in the system. Such a piecewise transfer may include object identification and piece identification information with the transfer of each piece of the object in addition to any transport or communication protocol information that is added as part of network communication processes such as TCP/IP, Ethernet, or other communication encoding.

BitTorrent, for example, includes piecewise transfer of objects. In a BitTorrent system, each object has a largely unique object identifier. The identifier is a unique 20 byte hash value derived from the object data. The object is further divided into a standard number of pieces by a standard process, with each piece of the object except for the last piece being a same size, and the last piece of the object being a smaller size than each other piece. A BitTorrent client may then communicate each piece across communication and network links to other BitTorrent clients on peer devices, with the piece of the object identified by the unique 20 byte identifier, an index value that identifies the position of the piece of the object with respect to other pieces of the object, and a hash value of the piece of the object for error checking purposes.

The embodiment described herein may thus apply to communication and upload of a single piece of an object, but within the context of a piecewise transfer of the entire object.

In 824, the server-side proxy such as server-side proxy device 321 receives the request for the piece of the object requested by the user device, and communicates that request to a peer or content provider that was previously identified using the peer-to-peer protocol. In 828, the server-side proxy receives the piece of the object, and transmits the piece of the object to the user device, where the piece is then received and stored by the user device in 832.

In 836, the server-side proxy analyzes the communication that included the piece of the object. This may include identifying the particular protocol used. This may also involve determining an object identifier associated with the object as part of the protocol. If the piece of the object was not previously stored at the server-side proxy, it may be stored at a memory associated with the proxy along with the identifier and any other relevant information depending on use or other tracking metrics that may identify the piece of the object as likely to be uploaded from a device coupled to the server-side proxy device.

In an embodiment involving BitTorrent, in order to separate BitTorrent streams from other TCP streams, a system may work to identify a BitTorrent handshake. First, the BitTorrent client will establish a TCP connection between the user device and a remote peer. The BitTorrent handshake appears in the first 20 bytes of the connection, as the hex value for 19, followed by the character stream “BitTorrent Protocol”. There are then two 20 byte strings, identifying both the info_hash of the torrent, and the peer_id of the client being connected to. After this, follows an uninterrupted stream of messages between the two clients. Messages follow a specific format, allowing a system to parse the stream for any relevant data. Parsing through these messages may enable identification of particular object pieces allowing a system to cache and store pieces of an object. Such pieces may each be stored as a separate file, or may be stored as files in groups of pieces where each group of pieces is less than the entire object. Further, the pieces may be stored according to the structure of pieces as created by the BitTorrent protocol.

As described above, all pieces in a single object as divided by the BitTorrent protocol are of uniform length, except for the final piece. The piece_length may be determined in the torrent file. The server-side proxy may not have access to the torrent file if it is only monitoring streams between clients. However, the server-side proxy can determine the piece length by comparing any two pieces we have captured for a given torrent. If the pieces are of the same size, then that size is our piece_length for the torrent. If one piece is smaller than the other, the smaller piece is the final piece of the torrent (the only one of irregular size), and the size of the larger piece is the piece_length of the whole torrent. This information may be used in identifying and sorting object pieces at the server-side proxy.

Further, BitTorrent pieces may be stored in a thread safe manner at the server-side proxy, as the system may be adding, retrieving and removing different pieces constantly. Such a system may use the info_hash or object identifier of the object as a fingerprint for different objects, since the info_hash is always unique for each object, and is only 20 bytes long, making it an excellent identifier for torrent objects. A system may also want to store which pieces have been cached and which pieces are still missing, which would allow the system to quickly determine if it should attempt to capture a given piece of an object. The server-side proxy may thus use a map of the object to track which pieces are cached for a given torrent object, using the torrent object's info_hash as a key along with a bitfield indicating cached pieces as the stored value. Individual pieces may be saved as separate files in a torrent object-specific directory. For example, in one potential embodiment, a location of a given piece may be:
:<cache_root9<info_hash>/<piece_index>.

This allows a system to keep storage organized and easy to access using the standard structure associated with the object by the peer-to-peer protocol. All accesses to the map will need to be locked, but once a system identifies what pieces are indexed for a torrent, the system may access the pieces safely without locking.

In 840, a request is then later received by a server-side proxy from a peer device for a copy of the piece of the object. This may be the same server-side proxy, or may be a related server-side proxy that shared cache or dictionary information including information on the object with the original server-side proxy. The request may come from any source, such as any peer device. The request may be made to the same user device of 820 and 832, or may be made to a different user device that has informed a swarm system that it has a copy of the piece of the object available for upload. In 842, this request is communicated to the user device that has a piece of the object available for upload. In 844, the user device receives the request and the peer-to-peer file transfer client checks and organized the requested piece of the object for communication. In 846, the server-side proxy may analyze the information in the received request, including identifying the object identifier and any index values associated with the piece of the object, in order to verify that the piece of the object is stored in the server-side storage. In 848, the presence of the piece of the object in memory available to the server-side proxy is communicated to the client-side proxy associated with the uploading user device, and in 850, the client-side proxy receives this confirmation message.

In 852, the peer-to-peer file transfer client operates to have the user device upload the piece of the object in response to the received request. In 856, the client-side proxy intercepts the communication from 852 based on the information received in 850, and compresses the communication using the information that client-side proxy received in 850. This compression may, for example, involve communicating an object identifier, index value, and a hash value associated with the object piece to the server-side proxy. In 860, the server-side proxy receives the compressed communication with the piece of the object from the client-side proxy, and decompresses the piece of the object using the copy stored in the memory accessible by the server-side proxy. In 864, the piece of the object is communicated from the server-side proxy device to the requesting peer as if the communication had come directly from the peer-to-peer file transfer client operating on the user device. Thus, the communication channel between the uploading user device and the server-side proxy device is minimized by compression, which may, for example, be dictionary compression as described above.

In alternative embodiments, when a request message from a peer is proxied through the server-side proxy as identified in 836, the server-side proxy can additionally look up the location of the piece in memory, and prepare the piece for transmission while the request continues through to the peer-to-peer file transfer client. By accessing and checking the cached piece as soon as the proxy client sees the request, the system may use the time that the CSP needs to verify the cached piece and also to ready the piece. When the file transfer client sends the requested piece, the proxy client can send a checksum of the piece to the server-side proxy as part of the compressed copy of the object to compare with the cached piece at the server-side proxy. If the checksums match, the server-side proxy can simply send the requested piece directly to the requesting peer, instead of sending the piece over the communication link from the user device to the server-side proxy.

In additional embodiments, in order to reduce bandwidth usage over a satellite link from a user device to a server-side proxy with limited memory, the system may analyze popular objects or torrents to determine how to allocate memory for caching. When a local client receives a request for a specific piece, the proxy client may intercept the outgoing data, and instead send a request to the server-side proxy indicating the info_hash, the index of the piece, and the requesting external client. If the specified piece is not found in the memory of the server-side proxy, the proxy client may allow the piece to pass normally to the server-side proxy, and then to the external requesting peer client. If the specified piece is already in the cache of the server-side proxy, the proxy client will squelch the outgoing piece from the user's local machine, and the server-side proxy will instead send out the corresponding piece to the requesting external client. This allows a system to avoid having to send the same piece over the satellite link multiple times, saving bandwidth on the network while not significantly impacting the user's experience. In order to ensure the cached piece being communicated from the server-side proxy matches the piece the client-side peer-to-peer file transfer client intended to send, the proxy client can send the SHA-1 checksum of the cached piece from the server-side proxy device to the proxy client. When the proxy client squelches the peer-to-peer file transfer client's piece message, the proxy client can also calculate the SHA-1 of the squelched piece, and compare it with the checksum of the cached piece that the server-side proxy is prepared to send. If the checksums do not match, the client-side proxy will send a short message to the server-side proxy, indicating the cached piece is different from the piece the user was going to send. The server-side proxy may then cancel sending its cached piece, remove the piece from the cache, and allow the piece message from the user's device to pass from the proxy client to the server-side proxy, and then out to its destination. While this new piece is passing through the server-side proxy, it may be captured and cached to reduce subsequent uploads from any user device making use of the server-side proxy device for uploads.

FIG. 9 now describes an embodiment for uplink optimization as implemented in a server-side proxy computing system. Such a server-side proxy computing system may be equivalent to server system 320, server-side proxy 321, or may be any other such implementation capable of performing the methods described herein. Such a server-side proxy computing system may comprise a single server device, or may comprise a distributed plurality of networked computing devices. In various embodiments, such a system may include multiple optimizers with a single memory for storing dictionary or object piece information shared by the optimizers, or any other such structure including optimizers for identifying information from data streams may be used in combination with any number of memory elements which cache object pieces for use in optimizing the upload stream to the server-side proxy.

As described by the embodiment of FIG. 9, 904 involves receiving, at a server-side proxy device, a portion of a piecewise transfer of an object to a first user device as part of a peer-to-peer file transfer protocol. The portion of the piecewise transfer of the object comprises an object identifier as part of the peer-to-peer file transfer protocol, and the object comprises a plurality of pieces that are communicated as part of the piecewise transfer using the peer-to-peer file transfer protocol. As described above, an example of a piecewise transfer is a BitTorrent transfer of an object that is split into multiple object pieces, with each piece communicates separately with identifying information attached to each piece by the file transfer protocol in addition to any transport information attached to the communication of the pieces of the object.

908 includes identifying, by the server-side proxy device, the peer-to-peer file transfer protocol and the object identifier from the portion of the piecewise transfer of the object and storing as separate files by the server-side proxy device, each portion of the object received via the peer-to-peer file transfer protocol, including at least a first piece of the plurality of pieces of the object identified by the server-side proxy device. Such identification may be particularly performed by an optimizer module of a server-side proxy that scans other information, and which may include network traffic for a large number of user systems including non-peer-to-peer communications. For example, the system may identify web page transactions, hosted file downloads, or other such network traffic in addition to peer-to-peer traffic, with a particular response invoked when a communication via an optimizable peer-to-peer protocol is identified.

912 comprises receiving, at the server-side proxy device, a notification associated with a transfer, using the peer-to-peer file transfer protocol, of the first piece of the object from the first user device to a second user device via the server-side proxy device.

916 involves communicating from the server-side proxy device to a first client-side proxy associated with the first user device, a confirmation that the first piece of the object is stored at the server-side proxy device, and 920 includes receiving, from the first client-side proxy, a compressed copy of the first piece of the object. Finally, 924 describes communicating from the server-side proxy device to the second user device, the first piece of the object as stored by the server-side proxy device. While the method described in FIG. 9 above includes particular aspects, the steps of such a method may be performed in conjunction with other steps performed in between, or in any combination or order that enables optimization of the uplink as described herein.

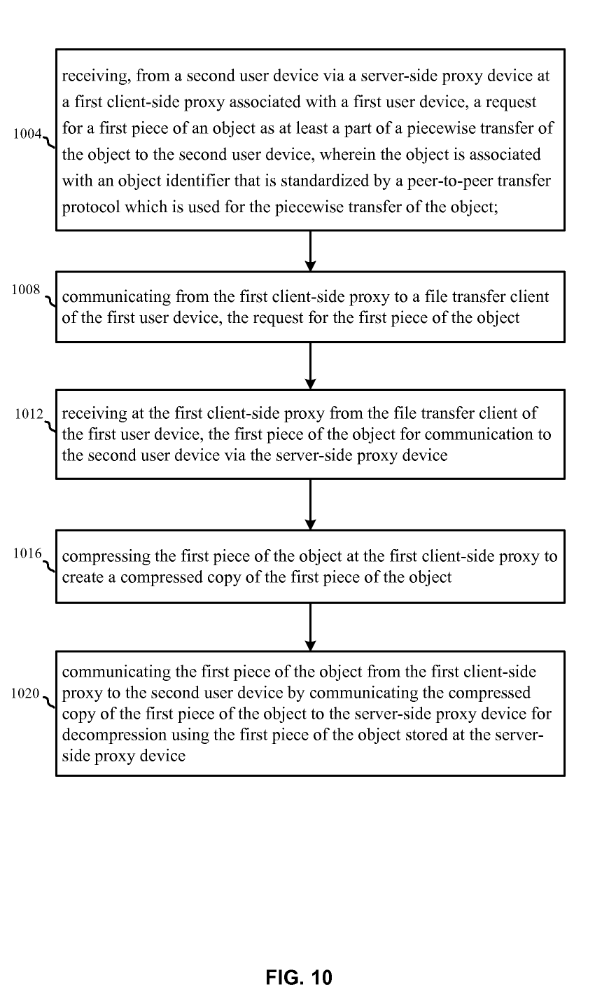

FIG. 10 now describes an additional embodiment directed to a method which may be performed by a client-side system. Such a system may be a system such as user system 210 of FIG. 2A, or the combination of first user device 211 with client-side proxy 221. While such examples are described herein, other potential embodiments may include a client-side proxy as a standalone device, such as a modem that may be coupled to multiple user devices, or a single device with an integrated client-side proxy. Additionally, in any embodiment described herein, a client-side proxy may be implemented in multiple parts, with a portion of the client-side proxy implemented in a separate device from a user device, and another portion of the same client-side proxy implemented on the user device.

As described by FIG. 10, 1004 involves receiving, from a second user device via a server-side proxy device at a first client-side proxy associated with a first user device, a request for a first piece of an object as at least a part of a piecewise transfer of the object to the second user device. As part of such a piecewise communication, the object will be associated with an object identifier that is standardized by a peer-to-peer transfer protocol which is used for the piecewise transfer of the object. In certain embodiments, the request will have been previously prepared by a negotiation between compatible peer-to-peer file transfer protocol clients of the first and second user devices. Such a request may include a request for the entire object, or simple for one or more pieces of the object as identified by the file transfer protocol being used for the file transfer. The second client may or may not have an associated client-side proxy.

1008 includes communicating from the first client-side proxy to a file transfer client of the first user device, the request for the first piece of the object, and 1012 includes receiving at the first client-side proxy from the server-side proxy device, an indication that the first piece of the object is stored at the server-side proxy device. Such a communication may be structured without specific information relating to the client-side proxy. Instead, this may be structured as a communication to the peer which is independent of the client and server proxies, but which will naturally flow to the client-side proxy.

1012 comprises receiving at the first client-side proxy from the file transfer client of the first user device, the first piece of the object for communication to the second user device via the server-side proxy device. This may be viewed as the client-side proxy intercepting the communication between peers for optimization. 1016 then comprises compressing the first piece of the object at the first client-side proxy to create a compressed copy of the first piece of the object which will reduce usage of a network link which connects the user device and client-side proxy with the server-side proxy.

1020 then comprises communicating the first piece of the object from the first client-side proxy to the second user device by communicating the compressed copy of the first piece of the object to the server-side proxy device for decompression using the first piece of the object stored at the server-side proxy device. The decompressed copy will then be communicated to the second user device in a way that the optimization will be transparent to the second user device when it receives the piece of the object.

Just as above for FIG. 9, while the method described in FIG. 10 includes particular aspects, the steps of such a method may be performed in conjunction with other steps performed in between, or in any combination or order that enables optimization of the uplink as described herein.

The above description is intended to provide various embodiments of the invention, but does not represent an exhaustive list of all embodiments. For example, those of skill in the art will appreciate that various modifications are available within the scope of the invention. Further, while the disclosure includes various sections and headings, the sections and headings are not intended to limit the scope of any embodiment of the invention. Rather, disclosure presented under one heading may inform disclosure presented under a different heading. For example, descriptions of embodiments of method steps for handling overlapping content requests may be used to inform embodiments of methods for handling anticipatory requests.

Specific details are given in the above description to provide a thorough understanding of the embodiments. However, it is understood that the embodiments may be practiced without these specific details. For example, well-known processes, algorithms, structures, and techniques may be shown without unnecessary detail in order to avoid obscuring the embodiments. Implementation of the techniques, blocks, steps, and means described above may be done in various ways. For example, these techniques, blocks, steps, and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field-programmable gate arrays (FPGAs), soft core processors, hard core processors, controllers, micro-controllers, microprocessors, other electronic units designed to perform the functions described above, and/or a combination thereof. Software can be used instead of or in addition to hardware to perform the techniques, blocks, steps, and means.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. Similarly, terms like “cache” are intended to broadly include any type of storage, including temporary or persistent storage, queues (e.g., FIFO, LIFO, etc.), buffers (e.g., circular, etc.), etc. The term “machine-readable medium” includes, but is not limited to, portable or fixed storage devices, optical storage devices, wireless channels, and/or various other storage mediums capable of storing that contain or carry instruction(s) and/or data.

Further, certain portions of embodiments (e.g., method steps) are described as being implemented “as a function of” other portions of embodiments. This and similar phraseologies, as used herein, intend broadly to include any technique for determining one element partially or completely according to another element. In various embodiments, determinations “as a function of” a factor may be made in any way, so long as the outcome of the determination is at least partially dependent on the factor.

While the principles of the disclosure have been described above in connection with specific apparatuses and methods, it is to be clearly understood that this description is made only by way of example and not as limitation on the scope of the disclosure.

### APPENDIX

¹ “BitTorrent” is a registered trademark or trademark of BitTorrent, Inc. and/or its affiliates.
² “Microsoft” and “Internet Explorer” are either registered trademarks or trademarks of Microsoft Corporation in the United States and/or other countries.
³ “Mozilla” and “Firefox” are registered trademarks of the Mozilla Foundation.
⁴ “Netscape” and “Netscape Navigator” are registered trademarks of Netscape Communications Corporation in the United States and other countries.
⁵ “Java” is a registered trademark of Oracle and/or its affiliates. Other names may be trademarks of their respective owners.

What is claimed is:

1. A method of compressing file uploads comprising:
receiving, at a server-side proxy device, a portion of a piecewise transfer of an object to a first user device as part of a peer-to-peer file transfer protocol, wherein the portion of the piecewise transfer of the object comprises an object identifier as part of the peer-to-peer file transfer protocol, and, wherein the object comprises a plurality of pieces that are communicated as part of the piecewise transfer using the peer-to-peer file transfer protocol;
identifying, by the server-side proxy device, the peer-to-peer file transfer protocol and the object identifier from the portion of the piecewise transfer of the object;
storing as separate files by the server-side proxy device, each piece of the object received via the peer-to-peer file transfer protocol, including at least a first piece of the plurality of pieces of the object identified by the server-side proxy device;
receiving, at the server-side proxy device, a notification associated with a transfer, using the peer-to-peer file transfer protocol, of the first piece of the object from the first user device to a second user device via the server-side proxy device;
receiving, from the second user device via the server-side proxy device at a first client-side proxy associated with the first user device, a request for the first piece of the object as part of the piecewise transfer of the object to the second user device;
communicating from the first client-side proxy to a file transfer client of the first user device, the request for the first piece of the object, wherein the file transfer client is associated with the peer-to-peer file transfer protocol;
communicating from the server-side proxy device to the first client-side proxy, a confirmation that the first piece of the object is stored at the server-side proxy device;
receiving at the first client-side proxy from the server-side proxy device, the confirmation that the first piece of the object is stored at the server-side proxy device;
receiving at the first client-side proxy from the file transfer client of the first user device, the first piece of the object for communication to the second user device via the server-side proxy device;
compressing the first piece of the object at the first client-side proxy to create a compressed copy of the first piece of the object;
communicating the first piece of the object from the first client-side proxy to the second user device by communicating the compressed copy of the first piece of the object to the server-side proxy device for decompression using the first piece of the object stored at the server-side proxy device;
receiving, from the first client-side proxy, the compressed copy of the first piece of the object;
decompressing the compressed copy of the first piece of the object using the first piece of the object stored at the server-side proxy device; and
communicating from the server-side proxy device to the second user device, the first piece of the object created by decompressing the compressed copy of the first piece of the object using the first piece of the object stored at the server-side proxy device.

2. The method of claim 1 wherein the notification associated with the transfer of the first piece of the object from the first user device to the second user device is a request message from the second user device to the first user device for the first piece of the object as part of a file transfer protocol structuring the piecewise transfer.

3. The method of claim 2 further comprising:
in response to receiving the request message, queuing, by the server-side proxy device, the first piece of the object for communication to the second user device prior to receiving the compressed copy of the first piece from the first client-side proxy.

4. The method of claim 1 wherein the compressed copy of the first piece of the object is a checksum of the first piece of the object.

5. The method of claim 1 wherein the notification associated with the transfer of the first piece comprises the object identifier, an index value associated with the first piece of the object, and a checksum of the first piece of the object.

6. The method of claim 1 further comprising:
storing by the server-side proxy device, a second piece of the plurality of pieces of the object identified by the server-side proxy device as part of the portion of the piecewise transfer.

7. The method of claim 6 wherein the object consists of the plurality of pieces, and the plurality of pieces consists of (1) a plurality of object length pieces each having a same object length set as a piece length, and (2) an ending object having an object length less than the piece length.

8. The method of claim 7 further comprising determining the piece length by:
identifying a first size of the first piece of the object and a second size of the second piece of the object; and
setting a larger size or an equal size of the first size and the second size as the piece length;
wherein the piece length is stored on the server-side proxy device.

9. The method of claim 1 wherein each piece of the plurality of pieces of the object is associated with a different index value identifying a relative location of each piece within the object.

10. The method of claim 9 wherein storing the first piece of the object at the server-side proxy device comprises storing the first piece of the object with the object identifier and an index value associated with the first piece of the object that identifies the relative location of the first piece within the object.

11. The method of claim 10 wherein the object identifier is a 20 byte hash value.

12. The method of claim 11 wherein storing the first piece of the object at the server-side proxy device comprising creating a file structure with a first level associated with the object identifier and a second level below the first level, wherein the second level is associated with the index value associated with the first piece of the object.

13. The method of claim 1 wherein identifying, by the server-side proxy device, the portion of the piecewise transfer of the object comprises:
identifying a peer-to-peer handshake in a communication between two peer devices.

14. The method of claim 13 further comprising:
identifying the object identifier, the first piece of the object, and an index value associated with the first piece of the object as part of the communication between two peer systems in a TCP connection.

15. A method of compressing file uploads comprising:
receiving, at a server-side proxy device, a portion of a piecewise transfer of an object to a first user device as part of a peer-to-peer file transfer protocol, wherein the portion of the piecewise transfer of the object comprises an object identifier as part of the peer-to-peer file transfer protocol, and, wherein the object comprises a plurality of pieces that are communicated as part of the piecewise transfer using the peer-to-peer file transfer protocol;
identifying, by the server-side proxy device, the peer-to-peer file transfer protocol and the object identifier from the portion of the piecewise transfer of the object;
storing as separate files by the server-side proxy device, each piece of the object received via the peer-to-peer file transfer protocol, including at least a first piece of the plurality of pieces of the object identified by the server-side proxy device;
receiving, at the server-side proxy device, a notification associated with a transfer, using the peer-to-peer file transfer protocol, of the first piece of the object from the first user device to a second user device via the server-side proxy device;
communicating from the server-side proxy device to a first client-side proxy associated with the first user device, a confirmation that the first piece of the object is stored at the server-side proxy device;
receiving, from the first client-side proxy, a compressed copy of the first piece of the object; and
communicating from the server-side proxy device to the second user device, the first piece of the object as stored by the server-side proxy device.

16. The method of claim 15 wherein each piece of the plurality of pieces of the object is associated with a different index value identifying a relative location of each piece within the object.

17. The method of claim 16 wherein storing the first piece of the object at the server-side proxy device comprises storing the first piece of the object with the object identifier and an index value associated with the first piece of the object that identifies the relative location of the first piece within the object; and
wherein the object identifier is a 20 byte hash value.

18. The method of claim 17 wherein storing the first piece of the object at the server-side proxy device comprising creating a file structure with a first level associated with the object identifier and a second level below the first level, wherein the second level is associated with the index value associated with the first piece of the object.

19. A method of compressing file uploads comprising:
receiving, from a second user device via a server-side proxy device at a first client-side proxy associated with a first user device, a request for a first piece of an object as at least a part of a piecewise transfer of the object to the second user device, wherein the object is associated with an object identifier that is standardized by a peer-to-peer transfer protocol which is used for the piecewise transfer of the object;
communicating from the first client-side proxy to a file transfer client of the first user device, the request for the first piece of the object;
receiving at the first client-side proxy from the server-side proxy device, an indication that the first piece of the object is stored at the server-side proxy device;
receiving at the first client-side proxy from the file transfer client of the first user device, the first piece of the object for communication to the second user device via the server-side proxy device;
compressing the first piece of the object at the first client-side proxy to create a compressed copy of the first piece of the object; and
communicating the first piece of the object from the first client-side proxy to the second user device by communicating the compressed copy of the first piece of the object to the server-side proxy device for decompression using the first piece of the object stored at the server-side proxy device.

20. The method of claim 19 wherein each piece of the plurality of pieces of the object is associated with a different index value identifying a relative location of each piece within the object; and
wherein storing the first piece of the object at the server-side proxy device comprises storing the first piece of the object with the object identifier and an index value associated with the first piece of the object that identifies the relative location of the first piece within the object.
